(19) United States
(12) Patent Application Publication
(10) Pub. No.: US 2010/0025221 A1
(43) Pub. Date: Feb. 4, 2010

(54) PROCESS FOR DISTILLATION OF MULTICOMPONENT MIXTURES INTO FIVE PRODUCT STREAMS

(75) Inventors: Rakesh Agrawal, West Lafayette, IN (US); Vishesh Shah, West Lafayette, IN (US); Arun V. Giridhar, West Lafayette, IN (US)

Correspondence Address: BRINKS HOFER GILSON & LIONE, P.O. BOX 10395, CHICAGO, IL, 60610, US

(73) Assignee: Purdue Research Foundation, West Lafayette, IN (US)

(21) Appl. No.: 12/533,411

(22) Filed: Jul. 31, 2009

Related U.S. Application Data
(60) Provisional application No. 61/085,246, filed on Jul. 31, 2008.
(60) Provisional application No. 61/104,494, filed on Oct. 10, 2008.

(51) Int. Cl. B01D 5/00

(52) U.S. Cl. 203/82

(57) ABSTRACT

Novel distillation processes for reducing the heat duty requirement of petroleum crude distillation as compared to the conventional distillation process are described. These processes are also applicable for distillation of other multi-component mixtures similar to petroleum crude.

### CROSS-REFERENCE TO RELATED APPLICATIONS

The present application claims the benefit of the filing date under 35 U.S.C. §119(e) for Provisional U.S. Patent Application Ser. No. 61/085,246, filed Jul. 31, 2008 and Provisional U.S. Patent Application Ser. No. 61/104,494, filed Oct. 10, 2008. All of the foregoing applications are hereby incorporated in their entirety by reference.

### FEDERALLY SPONSORED RESEARCH AND DEVELOPMENT

This invention was made with government support under Contract No. DE-FG36-06GO16104 awarded by the U.S. Department of Energy. The U.S. government may retain certain rights to the invention.

### FIELD OF THE INVENTION

The present invention relates to the separation of a multi-component mixture, more particularly petroleum crude, into five product streams. One aspect of the present invention is to describe novel distillation processes to separate a mixture into five product streams. Use of the invention will reduce energy consumption for the separation of petroleum crude and similar mixtures.

### BACKGROUND OF THE INVENTION

The conventional design for separating petroleum crude is a main column with side-strippers. This conventional design as shown in FIG. 1 has been the preferred choice in industry for almost 75 years. A thorough description of such a conventional design is provided by M. Bagajewicz and S. Ji, in “Rigorous Procedure for the Design of Conventional Atmospheric Crude Fractionation Units. Part I: Targeting”, Ind. Eng. Chem. Res. 2001, 40, pgs 617-626 the contents of which are herein incorporated by reference. In this conventional design, ABCDE is the feed mixture with ‘A’ being the most volatile component and the volatility decreasing in alphabetical order with ‘E’ being the least volatile.

Thermal coupling between two columns means replacing a non-product reboiler or a non-product condenser stream by a two-way liquid-vapor communication between the two columns. In FIG. 1, vapor stream 112 flowing from column 110 and liquid stream 114 flowing from column 100 is an example of thermal coupling between columns 100 and 110. In this conventional design, the feed stream ABCDE is fed to a main column 100. The section of this column below the feed plate enriches the liquid and vapor streams in the heaviest component E by stripping off the lighter components. The boil-up for this separation is provided by the direct injection of steam. Alternatively, a reboiler could be used. For the stages above the feed plate, component E is no longer present in the liquid or vapor stream(s) of the main column 100. In the current disclosure, when a component is stated to be no longer present in the stream(s) of a column, it is meant that the concentration of this component is below the acceptable low value for the stream(s) under consideration.

Referring again to FIG. 1, ABCD is transferred between the main column 100 and a side stripper 130 by means of a two-way liquid-vapor communication (streams 132 and 134) between the columns (e.g., thermal coupling). In the side stripper 130, steam is introduced by direct injection and all components except D, which is removed from the bottom, are stripped off. For the stages above the stage where ABCD is transferred, D is no longer present in the stream(s) of the main column 100. ABC is transferred between the main column and another side stripper 120 by means of another thermal coupling. Again, in this side stripper, steam is introduced by direct injection and all components are stripped off, except C, which is removed from the bottom. Similarly AB is transferred between the main column and a side stripper 110 and B is removed from the bottom of this side stripper. Finally A is removed from the top of the main column. All the locations where steam was introduced by direct injection could be replaced by reboilers.

The load on the condenser 140 of the main column can also be reduced by providing liquid pump-around loops in the main column. Liquid pump-around loops can be used to remove heat from intermediate locations of the feed column 100 as described by Liebmann K. and Dhole V. in “Integrated Crude Distillation Design”, Comput. Chem. Eng., 1995, 19, pgs 119-124, the contents of which are hereby incorporated by reference. In a pump-around loop, a liquid stream is withdrawn from an intermediate location of the column 100. The liquid stream is then cooled and returned to the column 100 at a location that is a few stages above the withdrawal location. The term, ‘stages’, as referred to in this disclosure means distillation trays or a section of the column packed with random or structured packing. Basically, ‘stages’ refer to vapor-liquid contacting devices that allow mass exchange between the two phases. Such mass exchange is essential for distillation.

In order to separate a five-component mixture ABCDE into five product streams, each stream enriched in one of the components, at least four distillation columns are necessary. However using more than four columns generally has no advantage. The term, ‘enrichment’, as used in this disclosure means that the concentration of a component is higher in the product stream than in the feed stream. There is no upper limit on the concentration in the product stream for which such configurations can be designed. Similarly, by a stream being ‘lean’ in a component, means that the concentration of the component in that stream is lower than in the feed stream.

Thermal coupling between columns enables one to rearrange column sections for easier operability as described by Agrawal and Fidkowski in U.S. Pat. No. 6,106,674 and by Agrawal in Chem. Eng. Res. & Des., 1999, 77, pgs 543-553, the contents of which are hereby incorporated by reference. The rearrangement of the column sections in the conventional configuration of FIG. 1, results in essentially the indirect sharp-split configuration described by Liebmann and Dhole in Comput. Chem. Eng., 1995, 19, pgs 119-124, the contents of which are hereby incorporated by reference. Referring now to FIGS. 2A and 2B, examples resulting from the rearrangement of column sections are shown. In FIG. 2a an upper portion of column 100 from FIG. 1 along with the associated condenser 140 and side stripping column is shown. The upper section I of column 200 above the thermal coupling point can be moved above the side stripping column 210 as shown in FIG. 2b. Both of the configurations shown in FIGS. 2a and 2b are thermodynamically equivalent, and for all practical purposes will have similar heat duties.

This can further be explained as follows—In FIG. 2a, some vapor rises through section 11 from the feed stage to the stage where AB is transferred. Also, the vapor from the side stripper, which is comprised of AB, enters the main column. These two vapor flows go through section I to the condenser 240 where A is pulled out. Next, the reflux at the top of the column flows down section I and reaches the stage where AB is transferred. Part of this liquid flow is transferred to the side stripper, while the remainder flows down the main column to the feed stage through section II.

The configuration shown in FIG. 2b also carries out exactly the same process as the configuration described above for FIG. 2a. In FIG. 2b, some vapor rises through section II from the feed stage to the stage where AB is transferred. This vapor is transferred to the side column, where it combines with the vapor from the stripping section of the side column. This side column performs similarly to the side stripper as previously shown in FIG. 2a. This combined vapor flow goes through section I to the condenser 240 where A is pulled out. The reflux at the top of this side column flows down through section I to the stage where AB is transferred. Part of this liquid flow continues down the side column, while the remainder flows down the first column to the feed stage through section II. Since the configurations shown in FIGS. 2a and 2b carry out exactly the same process, the energy requirement should also be identical. Thus thermal coupling makes it possible for one to rearrange column sections without substantially altering the process.

Referring now to FIG. 3, the indirect sequence resulting from the reduction of the conventional crude distillation configuration of FIG. 1 is shown for a particular case involving the distillation of petroleum crude ABCDE into five fractions—naphtha (A), kerosene (B), diesel (C), gas oil (D) and residue (E). These five fractions A, B, C, D, and E are listed in decreasing order of volatility. These fractions may be referred to differently by other authors, for example, Watkins in Petroleum Refinery Distillation (Gulf Publishing Company, Houston, Tex., 1979) refers to these five fractions as follows—naphtha (A), light distillate (B), heavy distillate (C), gas oil (D) and residue (E). The configuration shown in FIG. 3 is called the indirect sequence because the heaviest component of the feed is removed from each column. The configuration in FIG. 3 is obtained from the configuration shown in FIG. 1 by rearrangement of the column sections due to thermal coupling.

The addition of pre-fractionators and post-fractionators to the indirect sequence shown in FIG. 3 has been suggested by Brugma in U.S. Pat. No. 2,295,256 and by Liebmann and Dhole in Comput. Chem. Eng., 1995, 19, pgs 119-124 in order to reduce energy consumption. However, actual sequences or configurations that can be shown to reduce energy consumption have not been disclosed. Also, many sequences even with the addition of pre-fractionators and post-fractionators would not consume lower energy.

Thus a desire or need continually exists in the industry to provide particular distillation sequences that will reduce the energy consumed during the separation of a mixture, such as petroleum crude, into multiple product streams.

### BRIEF SUMMARY OF THE INVENTION

The present disclosure provides a process and a distillation system that uses particular sequences, which will reduce the energy consumption, for separating a mixture into five product streams. The various embodiments of the present disclosure are particularly applicable to the distillation of petroleum crude oil. More specifically, this disclosure describes a distillation column system containing four distillation columns used to separate a multi-component feed stock into five product streams with each stream being enriched in one of the feed components. In other words, a process comprising a distillation column system having four distillation columns is used to separate by distillation a feed stream containing at least five components, namely, A, B, C, D, and E with A being the most volatile and the volatility of each component decreasing in successive order with E being the least volatile, into product streams that are enriched in one of the components.

The process of the present disclosure generally comprises feeding the feed stream containing at least five components A, B, C, D, and E to the first distillation column of a distillation column system. One objective of the present disclosure is to provide a distillation column system in which the heaviest component, E, is recovered from the bottom of one of the distillation columns of the distillation column system. At least one of the streams selected from BCDE, CDE, and DE is then transferred between two distillation columns of the distillation column system. Component D is recovered from the bottom of one of the other three distillation columns of the distillation column system, provided said column is not the first distillation column to which the feed stream is fed. Component A is recovered from the top of one of the distillation columns of the distillation column system. Components B and C are recovered from suitable locations of the same or different distillation columns from among the other three distillation columns of the distillation column system.

According to one aspect for the above embodiment of the process, when exactly one of the streams selected from BCDE, CDE, and DE is transferred between two distillation columns of the distillation column system and this stream is BCDE; then BCD is transferred between two distillation columns of the distillation column system. Binary stream AB is then transferred between two distillation columns of the distillation column system. However, if ABCD is transferred from the first distillation column to one of the other three distillation columns of the distillation column system, then at least one of BC or CD is transferred between two distillation columns of the distillation column system, and ABC may or may not be transferred between two distillation columns of the distillation column system. If ABCD is not transferred between two distillation columns of the distillation column system, then all three streams—ABC, BC, and CD—are transferred between two distillation columns of the distillation column system.

According to another aspect of the above embodiment for the process, when exactly one of the streams selected from the group of BCDE, CDE, and DE is transferred between two distillation columns of the distillation column system and this stream is CDE, then stream ABCD is transferred from the first distillation column to one of the other three distillation columns of the distillation column system, and stream CD is transferred between two distillation columns of the distillation columns system. Binary stream AB is then transferred between two distillation columns of the distillation column system. However, if BCD is transferred between two distillation columns of the distillation column system, then streams ABCD and BC may or may not be transferred between two distillation columns of the distillation column system. If BCD is not transferred between two distillation columns of the distillation column system, then both ABC and BC is transferred between two distillation columns of the distillation column system.

According to yet another aspect for the above embodiment of the process, when exactly one of the streams selected from the group of BCDE, CDE, and DE is transferred between two distillation columns of the distillation column system and this stream is DE, then stream ABCD is transferred from the first distillation column to one of the other three distillation columns of the distillation column system, and stream BC is transferred between two distillation columns of the distillation column system. Binary stream AB is then transferred between two distillation columns of the distillation column system. However, if BCD is transferred between two distillation columns of the distillation column system, then streams ABC and CD may or may not be transferred between two distillation columns of the distillation column system. If BCD is not transferred between two distillation columns of the distillation column system, then both ABC and CD are transferred between two distillation columns of the distillation column system.

According to yet another aspect for the above embodiment of the process, when exactly two of the streams selected from the group of BCDE, CDE, and DE are transferred between two distillation columns of the distillation column system and these streams are CDE and DE, then stream AB is transferred between two distillation columns of the distillation column system. However, if BCD is transferred between two distillation columns of the distillation column system, then ABCD is transferred from the first distillation column to one of the other three distillation columns of the distillation column system, and at least one of streams selected from the group of BC and CD is transferred between two distillation columns of the distillation column system, and stream ABC may or may not be transferred between two distillation columns of the distillation column system. If BCD is not transferred between two distillation columns of the distillation column system, then streams ABC, BC, and CD are transferred between two distillation columns of the distillation column system, and stream ABCD may or may not be transferred from the first distillation column to one of the other three distillation columns of the distillation column system.

According to yet another aspect for the above embodiment of the process, when exactly two of the streams selected from the group of BCDE, CDE, and DE are transferred between two distillation columns of the distillation column system, and these streams are BCDE and DE, then AB may or may not be transferred between two distillation columns of the distillation column system. If AB is not transferred between two distillation columns of the distillation column system, then all of the streams—ABCD, ABC, BCD, BC, and CD—are transferred between two distillation columns of the distillation column system. However, if AB is transferred between two distillation columns of the distillation column system, then at least one of ABCD and BC are transferred between two distillation columns of the distillation column system, such that one of the following three situations occurs. First, if only ABCD is transferred from the first distillation columns to one of the other three distillation columns of the distillation column system, then streams BCD and CD are transferred between two distillation columns of the distillation column system, and stream ABC may or may not be transferred between two distillation columns of the distillation column system. Second, if only BC is transferred between two distillation columns of the distillation column system, then stream BCD is also transferred between two distillation columns of the distillation column system, and at least one of streams selected from ABC and CD is transferred between two distillation columns of the distillation column system. Third, if both ABCD and BC are transferred between two distillation columns of the distillation column system, then at least one of streams selected from the group of ABC, BCD, and CD is transferred between two distillation columns of the distillation column system.

According to yet another aspect of the above embodiment, when exactly two of the streams selected from the group of BCDE, CDE, and DE are transferred between two distillation columns of the distillation column system and these streams are BCDE and CDE, then stream CD is transferred between two distillation columns of the distillation column system. However, if stream AB is transferred between two distillation columns of the distillation column system, then at least one of streams selected from the group of ABCD and ABC is transferred between two distillation columns of the distillation column system, and at least one of streams selected from the group of BCD and BC is transferred between two distillation columns of the distillation column system. If stream AB is not transferred between two distillation columns of the distillation column system, then all of the streams—ABCD, ABC, BCD and BC—are transferred between two distillation columns of the distillation column system.

According to another aspect for the above embodiment of the disclosed process, when all three of the streams BCDE, CDE, and DE are transferred between two distillation columns of the distillation column system, stream BC may or may not be transferred between two distillation columns of the distillation column system. When stream BC is not transferred between two distillation columns of the distillation column system, then streams BCD, AB and CD are transferred between two distillation columns of the distillation column system, and either streams ABCD and ABC are both transferred or are both not transferred between two distillation columns of the distillation column system. When stream BC is transferred between two distillation columns of the distillation column system, then stream AB may or may not be transferred between two distillation columns of the distillation column system. If stream AB is not transferred between two distillation columns of the distillation column system, then stream CD is also not transferred between two distillation columns of the distillation column system, and all of the streams—ABCD, ABC and BCD—are transferred between two distillation columns of the distillation column system. If stream AB is transferred between two distillation columns of the distillation column system, then stream CD may or may not be transferred between two distillation columns of the distillation column system. In the case, where CD is transferred, then streams ABCD, ABC and BCD may or may not be transferred between two distillation columns of the distillation column system. In the case, where stream CD is not transferred, then at least two of streams selected from the group of ABCD, ABC and BCD are transferred between two distillation columns of the distillation column system.

Another objective of the present disclosure is to provide a process in which the heaviest component E in a feed stream with five components ABCDE is recovered from the bottom of the first distillation column of the distillation column system. In this embodiment, a four-component stream ABCD that is lean in the heaviest component E is then transferred from the first distillation column to one of the other three distillation columns of the distillation column system. Binary stream AB is transferred between two distillation columns of the distillation column system. At least one of the three-component streams selected from the group of ABC and BCD is transferred between two distillation columns of the distillation column system. Component D is recovered from the bottom of one of the other three distillation columns of the distillation column system. Component A is recovered from the top of one of the distillation columns of the distillation column system. Components B and C are recovered from suitable locations of the same or different distillation columns from among the other three distillation columns of the distillation column system.

During the transfer of at least one of the three-component streams selected from the group of ABC and BCD between two distillation columns of the distillation system, one of following three situations occurs. First, when only ABC is transferred, then at least one of the binary streams selected from the group of BC and CD is to be transferred between two distillation columns of the other three distillation columns of the distillation column system. Second, when only BCD is transferred, then binary stream BC is transferred between two distillation columns of the other three distillation columns of the distillation column system; and binary stream CD may or may not be transferred between two distillation columns of the other three distillation columns of the distillation column system. Third, when both of the three-component streams ABC and BCD are transferred, then at least one of the binary streams selected from the group of BC and CD is transferred between two distillation columns of the other three distillation columns of the distillation column system.

The process of the present disclosure may also include the partial or complete replacement of any reboilers with the direct injection of steam. In addition, the process may also include the partial or complete replacement of any condensers with liquid pump-around loops. The process may further comprise either partial or complete thermal coupling, as well as the rearrangement of distillation column sections due to such thermal coupling.

The process of the present disclosure is especially attractive when the mixture to be distilled is a petroleum crude mixture. This process may be a part of a larger distillation column system that ultimately produces more than five product streams. The process may also be heat integrated with other processes. The process may also incorporate two or more distillation columns into a single divided wall distillation column without exceeding the scope of the present disclosure.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic representation of a conventional four column distillation configuration used for petroleum crude distillation;

FIG. 2a is a schematic representation of multiple distillation sections in a thermally coupled distillation column system;

FIG. 2b is a schematic representation demonstrating how the multiple distillation sections from FIG. 2a can be moved from one distillation column to another to create an equivalent structure;

FIG. 3 is a schematic representation of a distillation column system that is an equivalent structure to the conventional configuration of FIG. 1;

FIGS. 4 to 11 are schematic representations of different distillation column systems each configured according to the teachings of the present disclosure;

FIG. 12 is a schematic representation of a distillation column system configuration that is equivalent to the distillation column system of FIG. 4 created by moving certain distillation sections from one distillation column to another distillation column;

FIGS. 13 to 27 are schematic representations of different distillation column system configurations each exhibiting a different degree of thermal coupling for the distillation column system of FIG. 12;

FIG. 28 is a schematic representation of a distillation column configuration with distillation sections appropriately moved from one distillation column to another distillation column;

FIG. 29 is a schematic representation of an equivalent configuration to FIG. 28 with distillation sections appropriately moved from one distillation column to another distillation column;

FIG. 30 is a schematic representation of another equivalent configuration to FIG. 28 with distillation sections appropriately moved from one distillation column to another distillation column;

FIG. 31 is an equivalent distillation column system of FIG. 9 configured by moving certain distillation sections from one distillation column to another distillation column;

FIG. 32 is an equivalent distillation column system of FIG. 9 configured with a divided wall column;

FIG. 33 is an equivalent distillation configuration of FIG. 9 where the distillation column providing binary stream BC has been incorporated into the distillation column producing component D at the bottom;

FIG. 34 is an equivalent distillation configuration of FIG. 29 and FIG. 30 where the distillation column providing binary stream BC has been incorporated into the distillation column providing ternary stream BCD;

FIGS. 35 to 97 are graphical representations of various distillation column systems designed according to the teachings of the present disclosure; and

FIG. 98 is a schematic representation of an equivalent distillation column system to the configuration described by the graph representation of FIG. 47.

### DETAILED DESCRIPTION OF THE INVENTION

The following description is merely exemplary in nature and is in no way intended to limit the present disclosure or its application or uses. It should be understood that throughout the description and drawings, corresponding reference numerals indicate like or corresponding parts and features.

This disclosure relates to the separation of a multi-component feedstock or mixture (preferably, petroleum crude) into five product streams. More specifically, a novel distillation process or system, including specific sequences or configurations that may be used to separate the mixture into five product streams is disclosed. Use of the distillation process or system disclosed herein will reduce energy consumption for the separation of petroleum crude and similar mixtures into their constituent components.

According to present disclosure various distillation column system configurations may be designed to separate a petroleum crude mixture into five product streams. In all these configurations, the transfer streams between any two distillation columns that either originate or terminate at the top or the bottom of at least one distillation column are thermally coupled. The arrangement of the distillation columns within each different distillation column system is also referred to as a distillation column configuration or distillation column sequence. Thus any of the phrases: distillation column system; column system; distillation column configuration; column configuration; distillation column sequence; or column sequence may be used to refer to the processes of the current disclosure. The petroleum crude may be distilled into five different fractions, namely, naphtha (A), kerosene (B), diesel (C), gas oil (D), and residue (E). These fractions are listed in decreasing order of volatility.

Sometimes it may not be desirable to process the heaviest component, i.e., the residue E in the petroleum crude mixture ABCDE. One objective of the present disclosure is to separate the residue E from ABCDE in the very first column (the feed column) of the distillation column system, and as a result, avoid transferring streams BCDE, CDE and DE between distillation columns of the distillation column system. According to one embodiment of the current disclosure total of eight different distillation column system configurations can be designed when the residue E is separated in the first column.

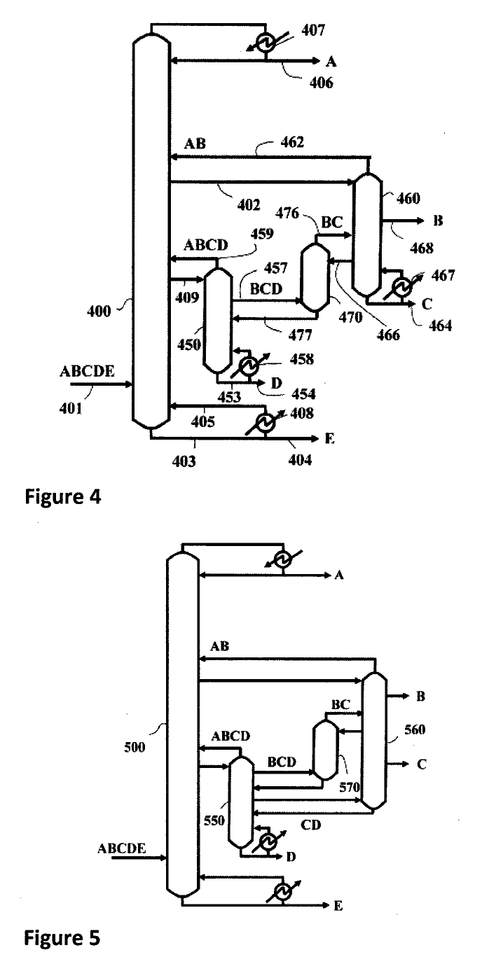

The first different distillation column system according to the above embodiment is shown in FIG. 4. The feed mixture ABCDE 401 is fed near the bottom of the first column 400. An appropriate number of separation stages are used between the feed location and the bottom of the first distillation column 400. A liquid stream 403 enriched in the heaviest component E (residue) is withdrawn from the bottom of the first distillation column. A portion of this stream is collected as liquid product stream 404 enriched in E, and the balance portion is vaporized in reboiler 408 to provide reboil duty for the first column through vapor stream 405. Next, an appropriate number of separation stages are used above the feed location such that after these stages, the concentration of the heaviest component E is reduced to the desired low value in the ascending vapor stream. There, a liquid stream 409 lean in component E (denoted as ABCD) is withdrawn and fed near the top of the second distillation column 450.

A vapor stream 459 containing essentially the same components A, B, C and D is withdrawn from the top of the distillation column 450 and fed to the first column 400 at roughly the same location from where the liquid stream 409 was withdrawn. Such two-way liquid vapor communication between two columns is referred to as thermal coupling between the columns. Another appropriate number of separation stages are used above the withdrawal location of stream 409 to further reduce the concentration of the next heavy components, namely, C (diesel) and D (gas oil), to the desired low values in the ascending vapor. A liquid stream 402 containing mainly components A and B is then drawn from the first column 400 and fed to the top of a third distillation column 460. A vapor stream 462 containing essentially the same components A and B is drawn from the top of this distillation column 460 and fed to the first distillation column 400 at roughly the same location as the withdrawal location of stream 402. Next, a number of separation stages are used above the liquid stream 402 withdrawal location in order to further decrease the concentration of component B to the desired low level in the ascending vapor.

The vapor leaving the top of the column 400 is condensed in condenser 407. When a total condenser is used a portion of the liquid stream leaving the condenser 407 is recovered as product stream 406 enriched in A, while the balance portion of the liquid stream is returned to column 400 as reflux. In place of the total condenser, one could also use a partial condenser, and establish a product stream 406 in the vapor phase instead. Next, the liquid stream 409 containing A, B, C and D descends through an appropriately chosen number of separation stages in the second distillation column 450 to reduce the concentration of the light components in the descending liquid. Once the concentration of component A is reduced below the desired low level, a vapor stream 457 containing predominantly B, C and D is withdrawn from the second distillation column 450 and fed near the bottom of the fourth distillation column 470.

In a thermal coupling mode between the two columns, a liquid stream 477 from the bottom of the fourth distillation column 470 is fed to the second distillation column 450 at roughly the same location as the withdrawal of stream 457. Next, a number of separation stages are used below the withdrawal location of vapor stream 457 to further reduce the concentration of components B and C below the desired low level in the descending liquid through the second column 450. A portion of the bottom liquid stream 453 from the second distillation column 450 is collected as liquid product stream 454 enriched in D, while the balance portion is vaporized in reboiler 458 to provide vapor reboiling for column 450. It should be emphasized that distillation sections consisting of appropriate number of separation stages are used between the top and the thermal coupling location involving streams 457-477, and between the thermal coupling location involving streams 457-477 and the bottom of the distillation column 450. Next, an appropriate number of separation stages are used in distillation column 470 to reduce the concentration of component D to an acceptable low value in the ascending vapor stream. From the top of this distillation column 470, a vapor stream 476 containing mainly components B and C is fed to the third distillation column 460. In a thermal coupling mode between columns 460 and 470, a liquid stream 466 is withdrawn from column 460 at roughly the same location as the feed location of stream 476, and is fed near the top of the distillation column 470.

Next, component B enriched stream is withdrawn from an intermediate location of the distillation column 460 as product stream 468. An appropriate number of separation stages are used in the distillation sections above and below the withdrawal location of stream 468 in distillation column 460. Finally the product stream enriched in component C is withdrawn from the bottom of the third distillation column 460. An appropriate number of separation stages are used in this lowest section of the third distillation column 460 to reduce the concentration of component B in the liquid stream as it descends the column. A portion of the liquid stream from the bottom of the third column 460 is vaporized in reboiler 467 to provide reboil for the column 460, while the other portion is collected as product stream 464 enriched in C.

The symbols ABCD, BCD, CD, etc. used in the process of FIG. 4 and the rest of the processes of the present disclosure are used to denote a submixture as it is generated from the feed mixture ABCDE. The absence of an alphabet in a submixture does not necessarily denote a total absence of that component in the submixture. It simply means that the concentration of the component with the missing alphabet is sufficiently lower than the acceptable level to provide a product stream of the desired purity. The concentration of the component with the missing alphabet is certainly below that in the feed. Thus in a submixture BCD, the concentration of both components A and E are at acceptable low values. Therefore when a mixture is referred to as ternary or three-component mixture, it does not necessarily mean that this mixture has exactly only three components. This is also true for quaternary mixture ABCD, ternary mixture ABC and binary mixtures AB, BC and CD.

It should also be pointed out that using ABCDE to denote the feed mixture does not necessarily restrict the number of components present in the feed to five. It means that the feed mixture can be subdivided into five fractions with each having different volatility than the other and each being denoted by an appropriate alphabet. Thus letter E (residue) may represent a number of components in the petroleum crude that are heavier than the components present in D (gas oil fraction). Similarly, gas oil fraction D can contain a number of components that are more volatile than the components in the residue E, but heavier than the components in the diesel fraction C; and so on.

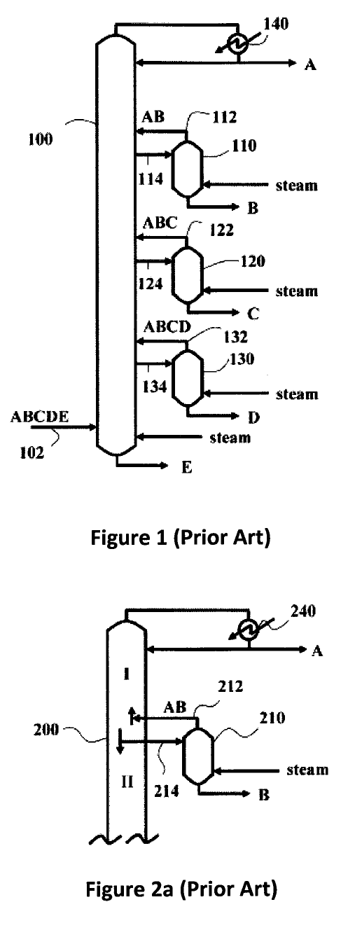

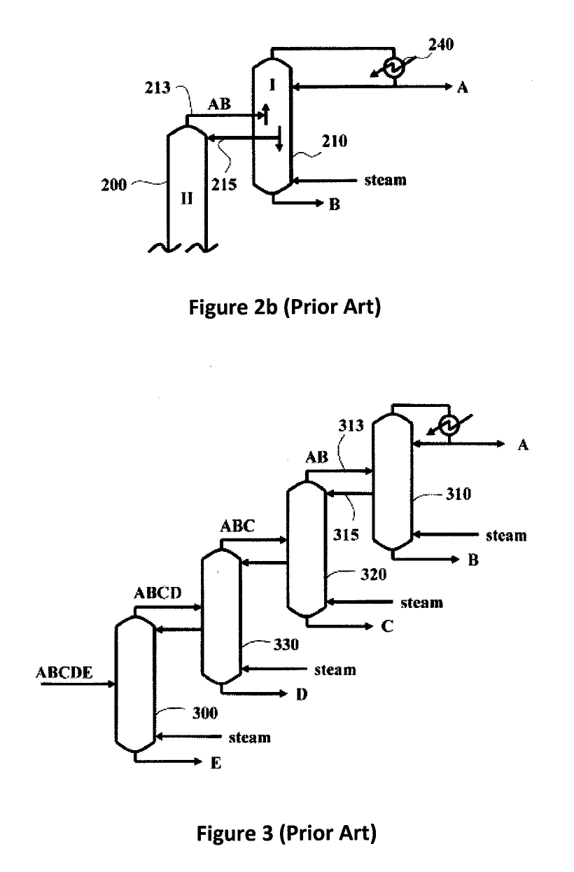

A key distinguishing feature of the process in FIG. 4 is the transfer of four submixture streams between the distillation columns. The first column 400 transfers submixture AB to the third distillation column 460 and ABCD to the second distillation column 450, which in turn transfers a three-component mixture BCD to the fourth distillation column 470, which in turn transfers a binary mixture BC to the third distillation column 460. Note that the transfer of streams BCD and BC between the columns has been missing from the conventional process of FIG. 1. These submixtures are mainly composed of the components of intermediate volatility, and the lightest component A and the heaviest component E are either absent, or are present in only appreciably low quantities.

A second distillation column system configuration designed according to the above embodiment is shown in FIG. 5. This second configuration is similar to the first configuration described above in that it transfers streams ABCD and AB from the first column 500, BCD from the second column 550, and BC from the fourth column 570. However, in this second configuration stream CD is transferred between two distillation columns. One skilled in the art will understand that the transfer of binary streams BC and CD is between two distillation columns, none of which is the column to which the feedstock is fed.

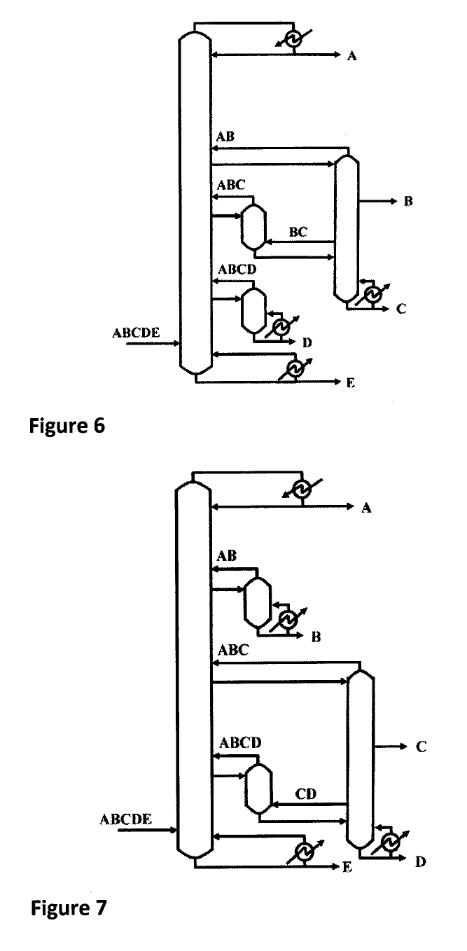

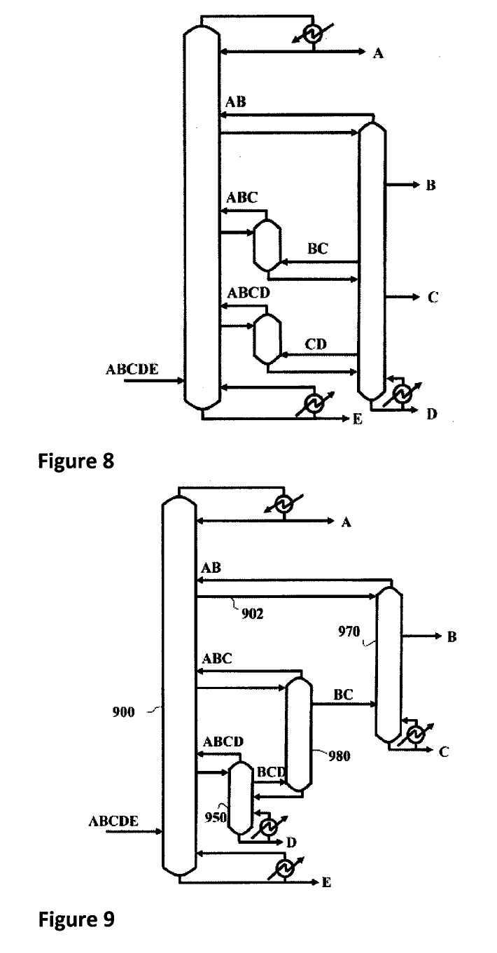

In the distillation system configurations of FIGS. 4 and 5, only one ternary mixture BCD is transferred from one distillation column to another. Other distillation system configurations, such as those shown in FIGS. 6-8, may also transfer one ternary mixture, i.e., ABC, from one distillation column to another, while also transferring binary stream BC (FIG. 6), CD (FIG. 7) or both BC and CD (FIG. 8) from one column to another. Transfer of streams BC and/or CD does not involve the first column to which the feedstock is fed. One skilled in the art will understand that in the configurations described in FIGS. 6-8, the transfer of binary mixture AB from one distillation column to another also occurs.

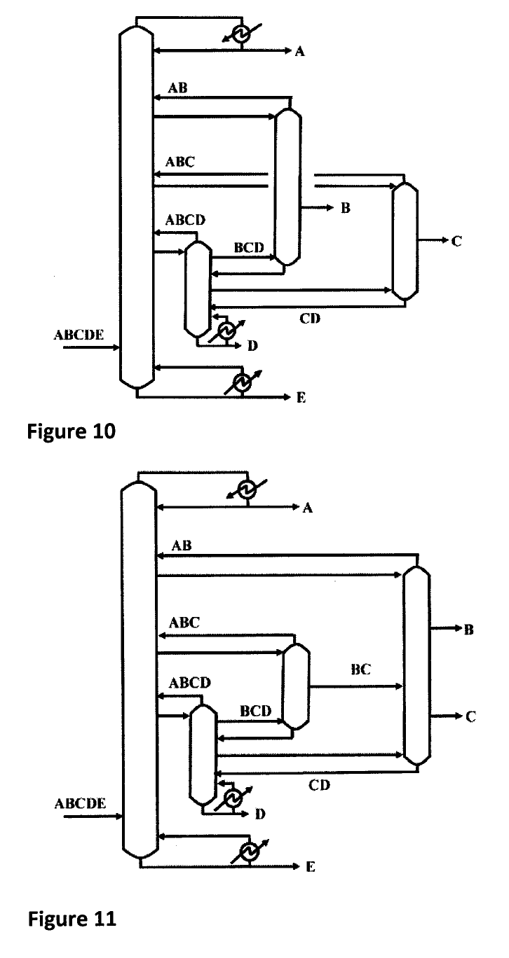

FIGS. 9-11 describe three other distillation system configurations designed according to the teachings of the above embodiment where both the ternary mixtures ABC and BCD are transferred from one distillation column to another. The ternary mixture BCD is transferred from a column other than the feed column. Once again, binary mixture AB is transferred from one distillation column to another distillation column and at least one of the binary streams selected from the group of BC and CD is transferred from one column to another. The transfer of binary stream BC leads to the configuration shown in FIG. 9, the transfer of binary stream CD leads to the configuration shown in FIG. 10, and the transfer of both binary streams BC and CD leads to the configuration shown in FIG. 11. Once again, the transfer of binary streams BC and/or CD is from distillation columns other than the first distillation column to which the feedstock is fed.

One skilled in the art will understand that in FIGS. 9 and 11 the transfer of binary stream BC is not shown as a two-way liquid vapor-communication of a thermally coupled transfer. The reason for this is that thermal coupling is achieved when the transfer of a stream involves either the top or the bottom of a distillation column at one of its ends. For example, in FIG. 9, the binary liquid stream AB 902 is transferred from an intermediate location of the first column 900 to a location near the top of the distillation column 970. Since the transfer stream terminates at the top of a column, the vapor stream from the top of the column 970 can be sent to the first column 900 to create thermal coupling. On the other hand, once again referring to FIG. 9, the binary mixture BC is withdrawn at an intermediate location of one column (980) and fed to an intermediate location of another column (970). In such a case, there is no necessity to use a return stream to create two-way communication. Hence transfer stream BC in FIGS. 9 and 11 represents a one-way communication between columns. The transfer stream may be a single phase vapor stream, a single phase liquid stream, or a two-phase liquid-vapor stream.

In the processes of the current disclosure, separation stages in a distillation column refer to mass contact devices allowing mass transfer between liquid and vapor phases. Several examples include, but are not limited to, various types of trays, structured packing, and random packing.

In FIGS. 4-11, all the transfer streams that have either the top or the bottom of a distillation column involved at one of its ends, are shown as thermally coupled. When in a distillation column system all such existing transfer stream connections have been converted to thermally coupled transfers, the distillation column system is completely thermally coupled. However, one skilled in the art will understand that even though the distillation column system configurations in FIGS. 4-11 are shown with complete thermal coupling, these configurations may also include reduced or partial thermal coupling.

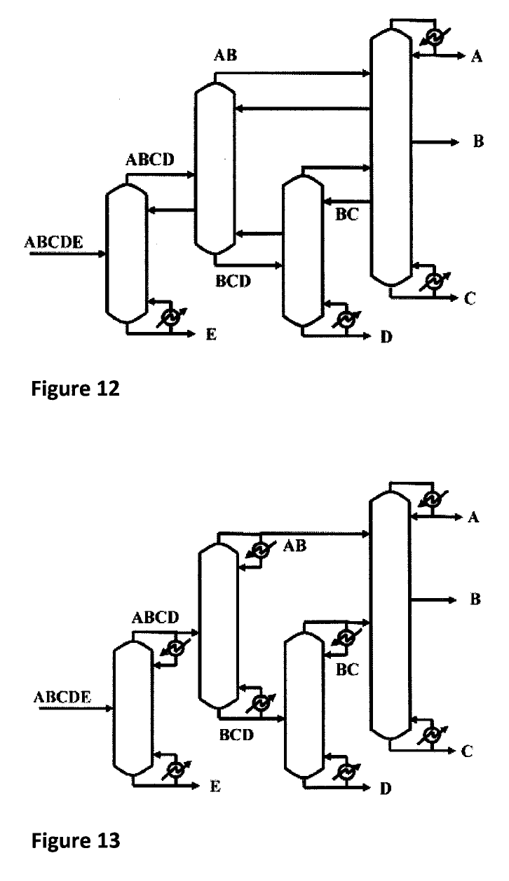

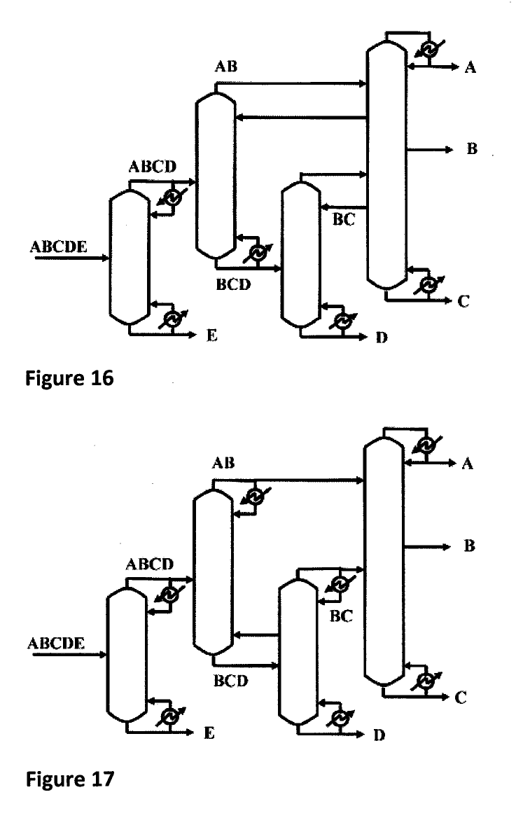

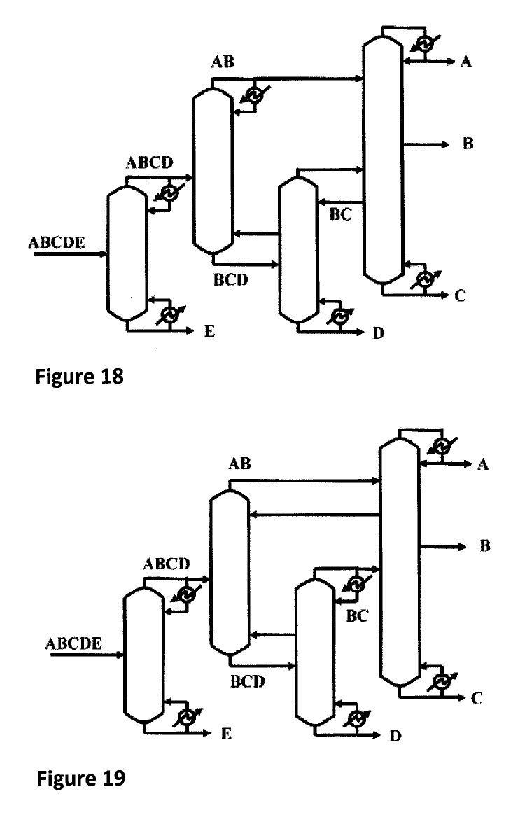

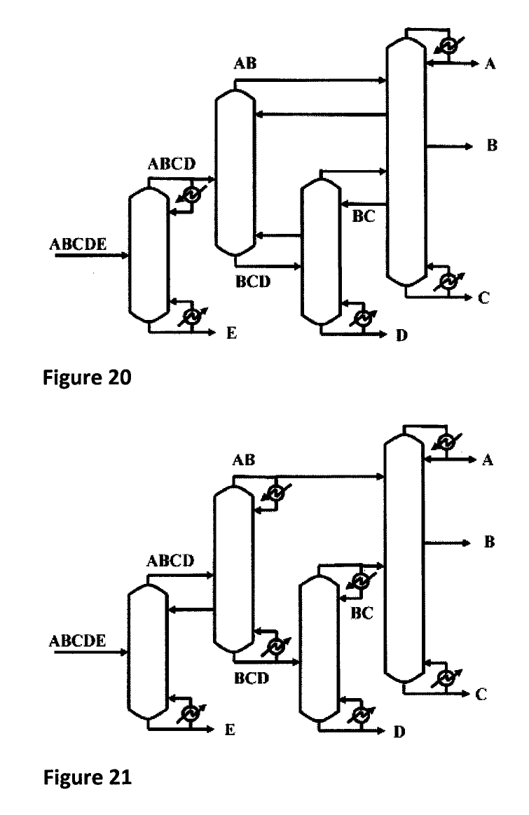

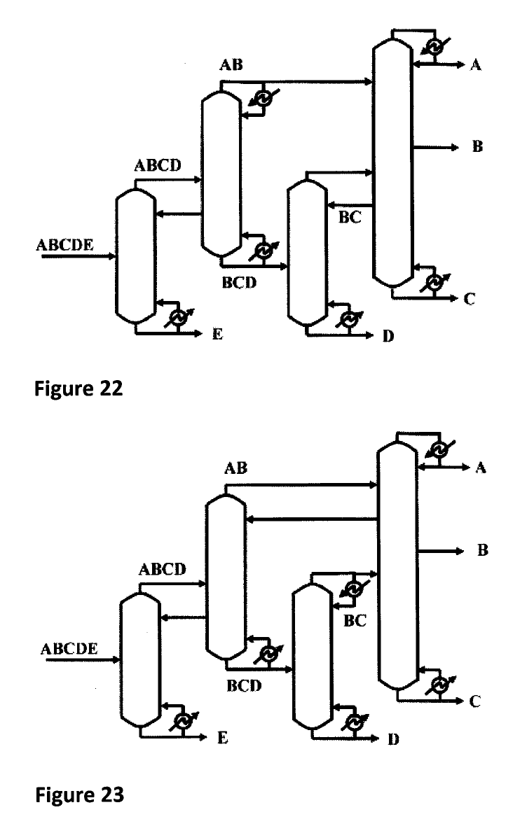

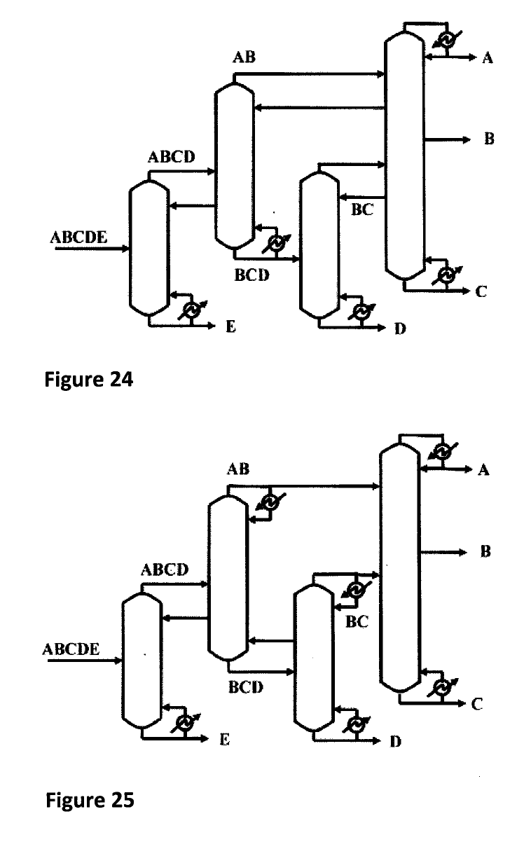

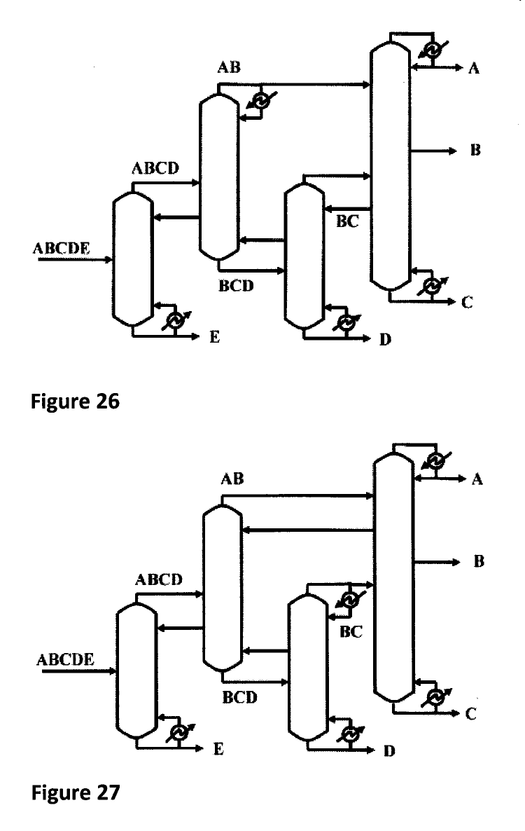

Referring to FIG. 4, the distillation column system is shown to have complete thermal coupling with the column sections being arranged in such a manner so that stream A is transferred from the top of the main column. Referring now to FIG. 12, rearrangement of the column sections can be done to provide another configuration that has equivalent sequences to the configuration shown in FIG. 4. In addition, if all the streams that are thermal coupled in FIG. 12 are replaced with reboilers and condensers as appropriate, a configuration as shown in FIG. 13 is obtained. Since the configuration shown in FIG. 13 has no thermal coupling, the column sections may not be rearranged to provide another configuration. However, one skilled in the art will understand that four streams, namely, ABCD, AB, BCD, and BC are candidate streams for establishing thermal coupling. If one systematically introduces thermal coupling into these streams, a total of 2⁴-1 or 15 configuration options are possible. These 15 possible configurations are shown in FIGS. 12-27, as well as being summarized in Table 1 below.

TABLE 1

| Streams Having | |
|---|---|
| Thermal Coupling | FIG. |
| “None” | 13 |
| BC | 14 |
| AB | 15 |
| AB, BC | 16 |
| BCD | 17 |
| BCD, BC | 18 |
| BCD, AB | 19 |
| BCD, AB, BC | 20 |
| ABCD | 21 |
| ABCD, BC | 22 |
| ABCD, AB | 23 |
| ABCD, AB, BC | 24 |
| ABCD, BCD | 25 |
| ABCD, BCD, BC | 26 |
| ABCD, BCD, AB | 27 |
| ABCD, BCD, AB, BC | 12 |

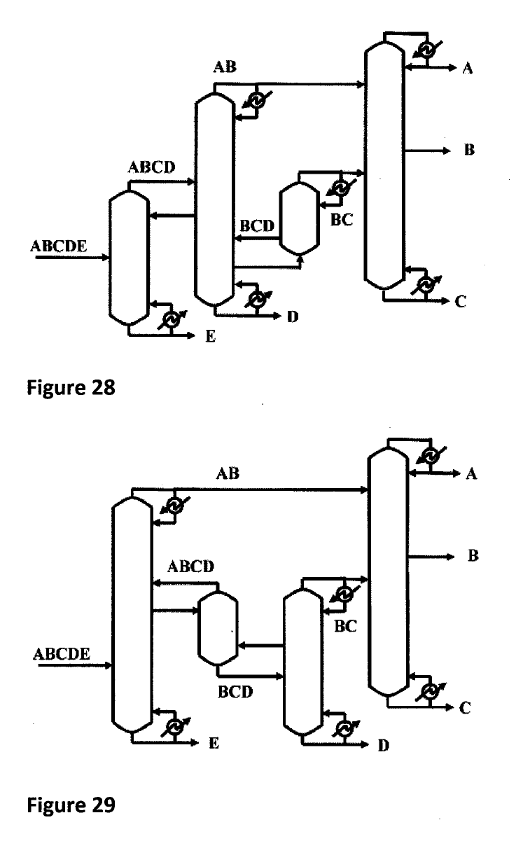

Further rearrangement of column sections is shown FIG. 25 and FIGS. 28-30. In FIG. 25, the column section where BCD forms D; and the column section where ABCD forms AB are the two sections which can be rearranged. The possible rearrangements for the distal column configuration of FIG. 25 are shown in FIGS. 28-30. One skilled in the art will understand that all the sequences shown in FIG. 25 and in FIGS. 28-30 will have substantially similar energy consumption. The only difference between these configurations is that some of them may be easier to control than the others.

Multiple different distal column configurations, which range from having partial to complete thermal coupling, may be derived from the distal column systems depicted in FIGS. 4-11. From the basic configurations depicted in FIGS. 4-11, one first identifies the various sections that can be rearranged and then draws each of the possible sequences. The designer, engineer, or operator may then choose the configuration or configurations that are easier to operate or that meet other predetermined or desirable system constraints. All such arrangements are covered by the process of this disclosure.

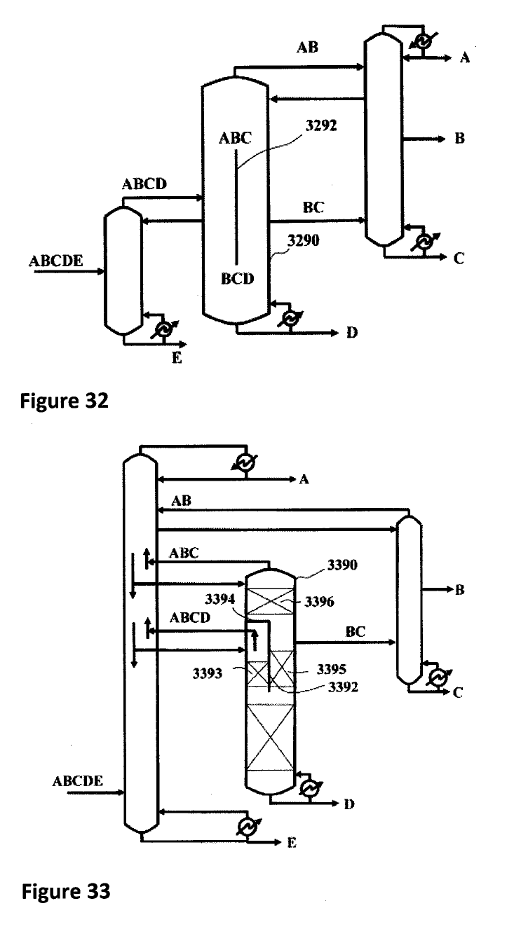

Some of the distillation column system configurations of the current disclosure may be drawn using three or less distillation columns even though in principle they are using four distillation columns. To illustrate this principle, one first may configure a distillation column system as shown in FIG. 31, which is derived from the configuration depicted in FIG. 9 by rearrangement of various column sections. Hence the configurations shown in FIG. 9 and FIG. 31 are substantially the same. Referring now to FIG. 32, an example of a distillation column system having a divided wall column is shown. The configuration shown in FIG. 32 is derived from the configuration depicted in FIG. 31. It is known that a completely thermally coupled two-column ternary distillation system can be drawn and built as one distillation column shell having a divided wall inside. Further description of such a system is provided by R. Wright in U.S. Pat. No. 2,471,134, the entirety of which is hereby incorporated by reference. Thus distillation columns 3150 and 3180 described in FIG. 31 can be built in one column shell 3290 with a divided wall 3292 extending from an intermediate location below the feed ABCD but above the bottom of the distillation column 3290, to another intermediate location above the feed ABCD but below the top of the distillation column 3290 without departing from the scope of the present disclosure.

In column shell 3290, the ternary mixture, BCD, is present near the bottom of the divided wall and the ternary mixture, ABC, near the top of the divided wall. The binary mixture, BC, withdrawal is positioned on the opposite side of the column 3290, from the feed (ABCD) inlet. Similarly, other configurations are also amenable to replacement of two distillation columns by a single divided wall column. For the purposes of the current disclosure, the divided wall column in FIG. 32 in principle operates as two distillation columns and the configuration in said Figure is considered to be a four column distillation configuration.

Referring now to FIG. 33, the distillation column system configuration shown may be derived from FIG. 9 or FIG. 31. This configuration represents another example where two distillation columns may be combined in one distillation column shell. Thus distillation columns 3150 and 3180 from FIG. 31 have been combined in one distillation column 3390 with a divided wall 3392. The top end of the divided wall 3392 is closed on the side of the feed ABCD such that there is no vapor or liquid flow across this enclosure 3394. The crossed areas in FIG. 33 show distillation column sections containing separation stages. Starting at the bottom of the divided wall 3392, a ternary vapor stream BCD ascends the column 3390 on both sides of the divided wall 3392. The binary mixture BC withdrawal is positioned on the opposite side of the column 3390, from the feed ABCD inlet. Thus distillation section 3395 acts as the bottom section of the distillation column 980 and distillation section 3396 acts as the top section of the distillation column 980. Distillation section 3393 is equivalent to the topmost section of distillation column 950. Hence, once again the distillation column system configuration of FIG. 33 incorporates two distillation columns into one column shell. Since column 3390 is performing as two distillation columns in principle, for the purposes of this invention, such a distillation column system is considered to be a four-column distillation system.

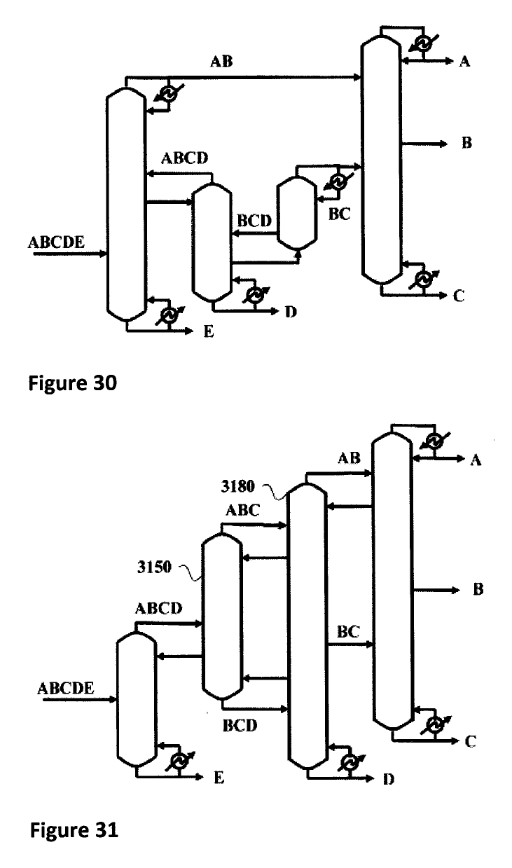

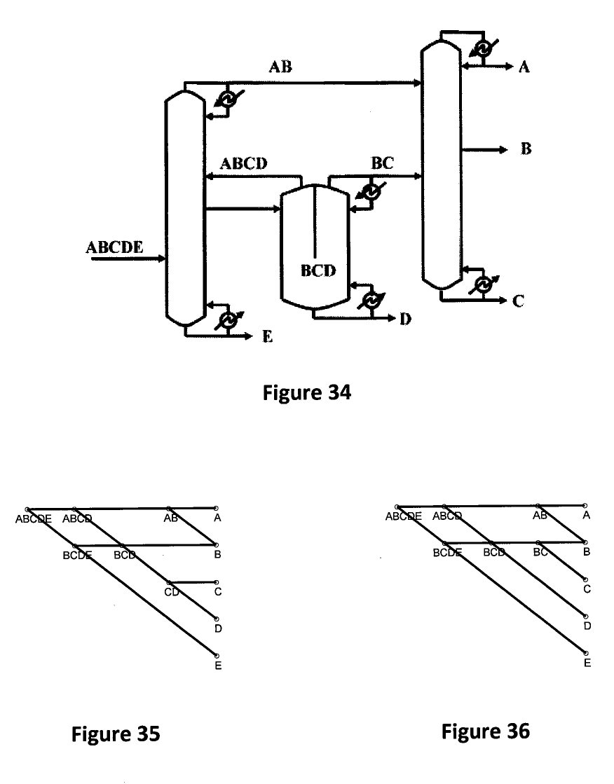

FIG. 29 and FIG. 30 both give rise to substantially the same configuration as shown in FIG. 34 where the distillation column producing binary stream BC and the distillation column providing ternary stream BCD are incorporated into a single distillation column having a divided wall. Such a column also performs as two distillation columns in principle and for the purposes of this invention, such a distillation column system is also considered as being a four-column distillation system.

Another objective of the present disclosure is to provide distillation column system configurations in which the heaviest component, residue E, is separated from the bottom of one of the distillation columns of the distillation column system other than the first column. In this embodiment of the present disclosure, a total of sixty-three distillation column configurations, which will consume lower energy than the conventional design (FIG. 1) for separating petroleum crude can be designed to allow for transfer of streams BCDE, CDE and DE between distillation columns.

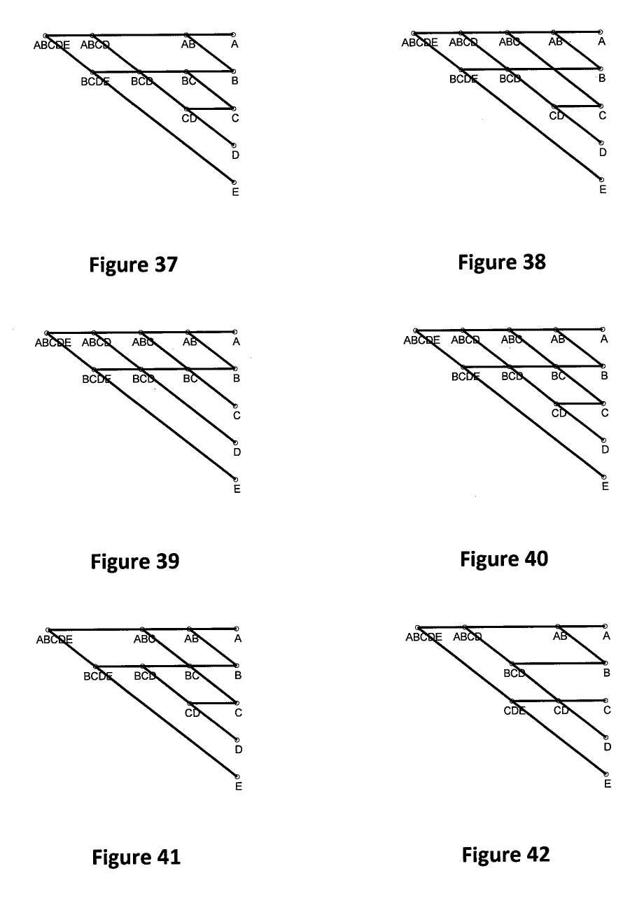

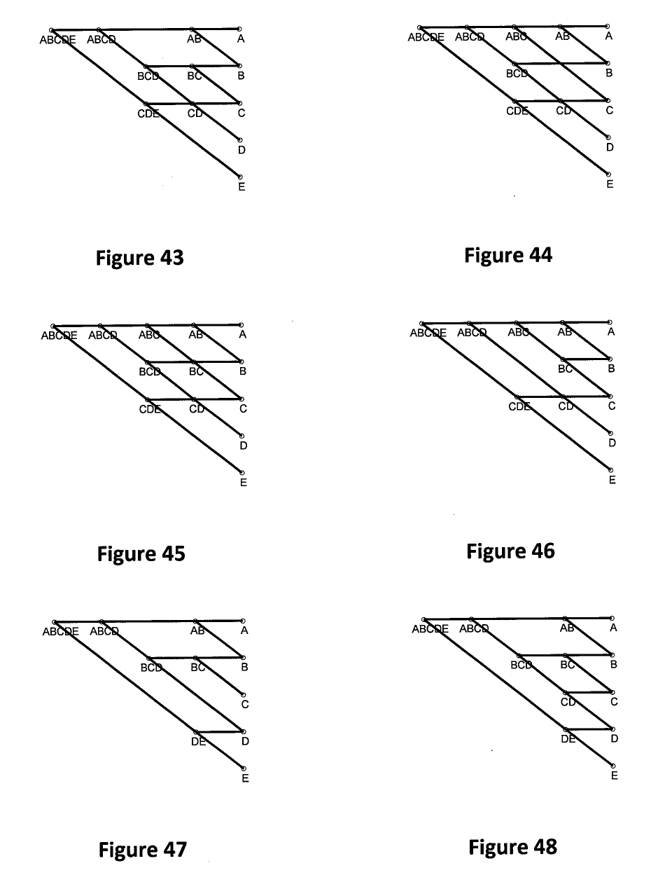

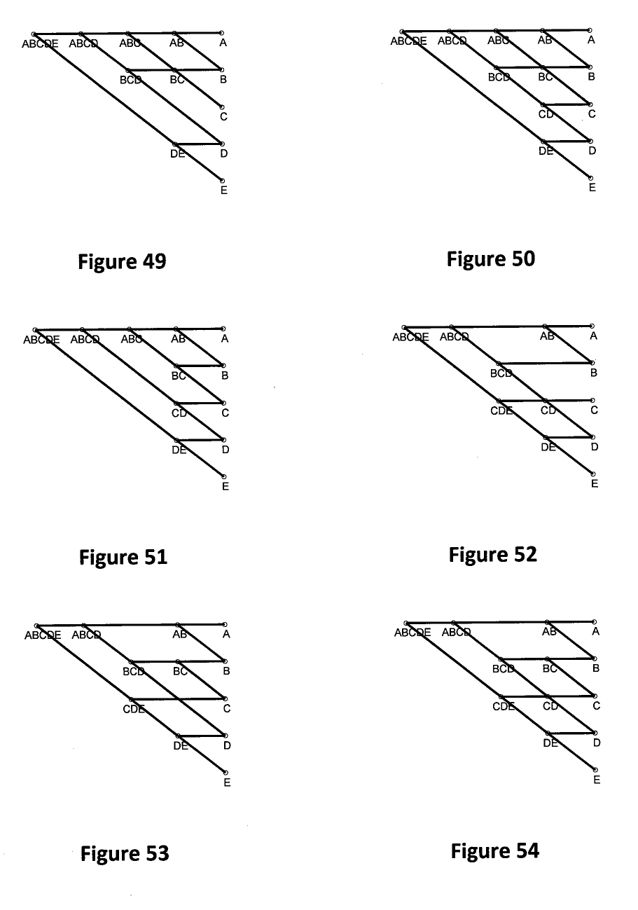

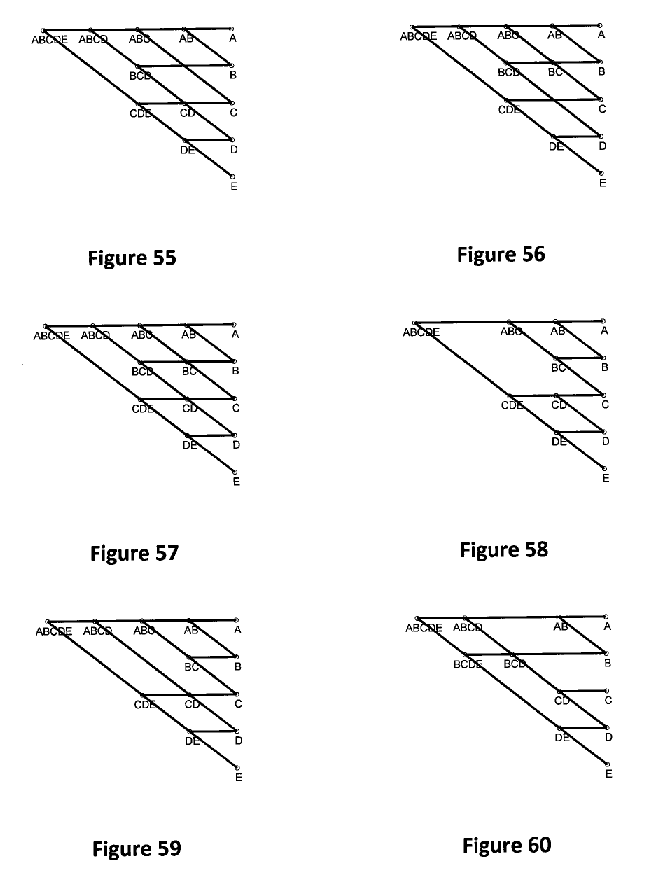

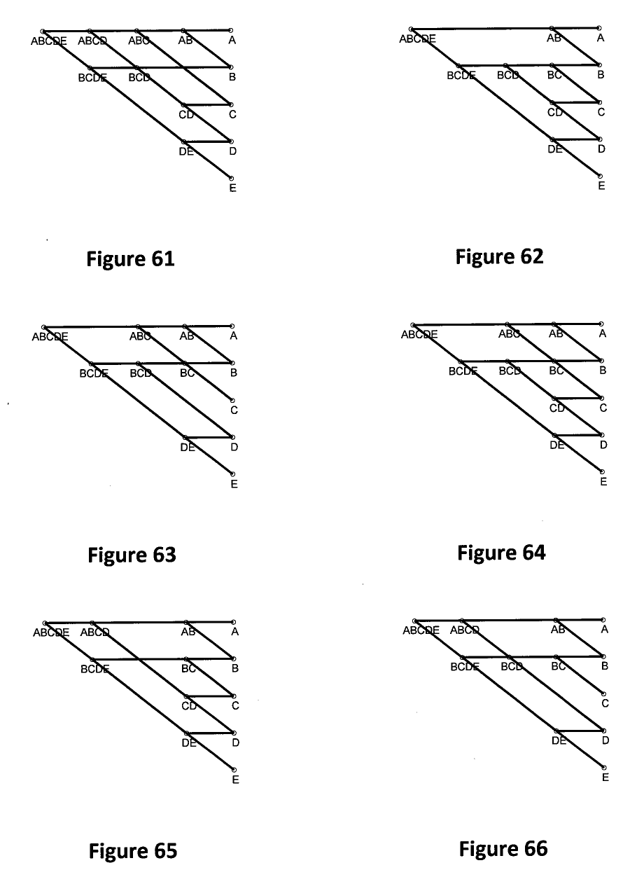

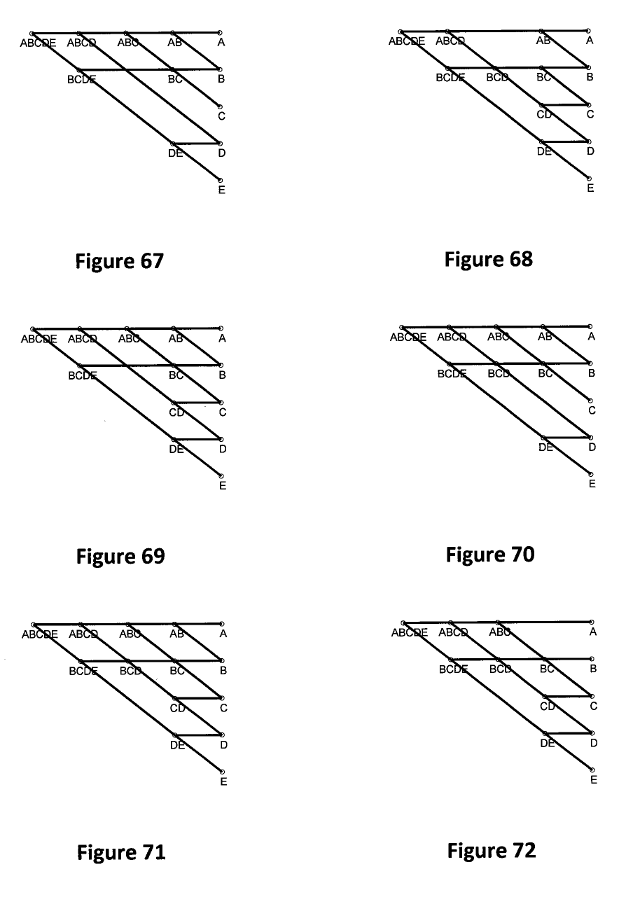

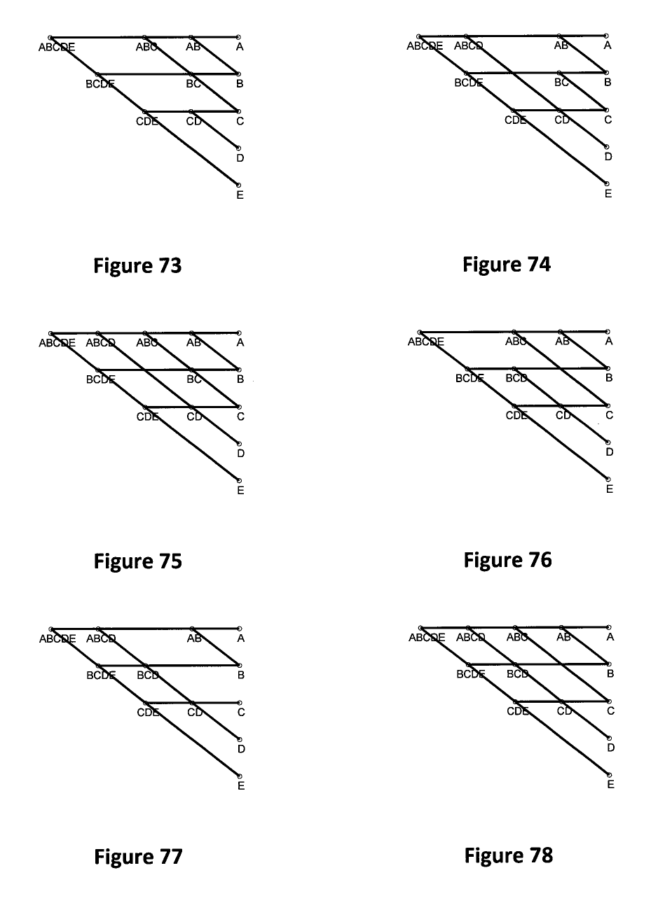

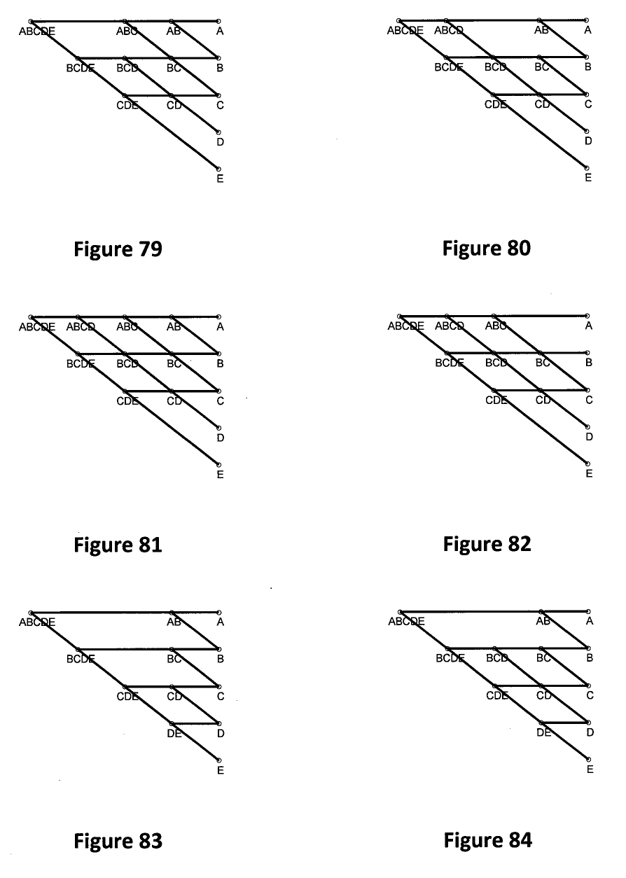

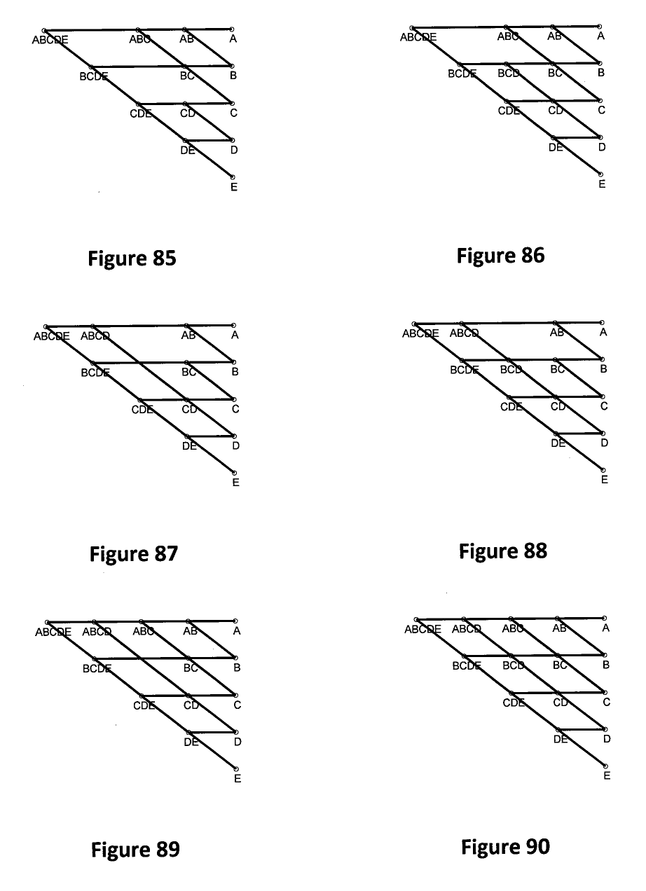

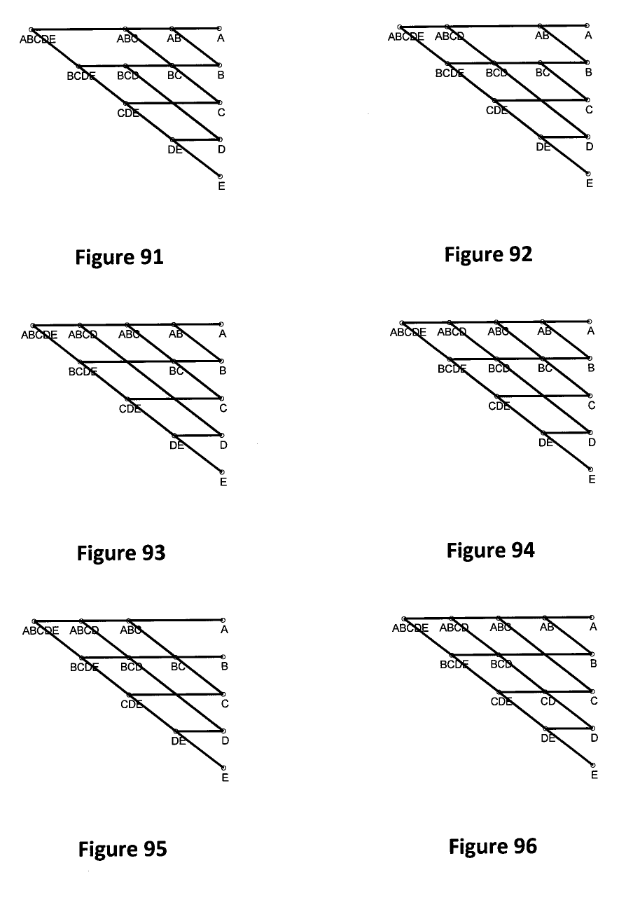

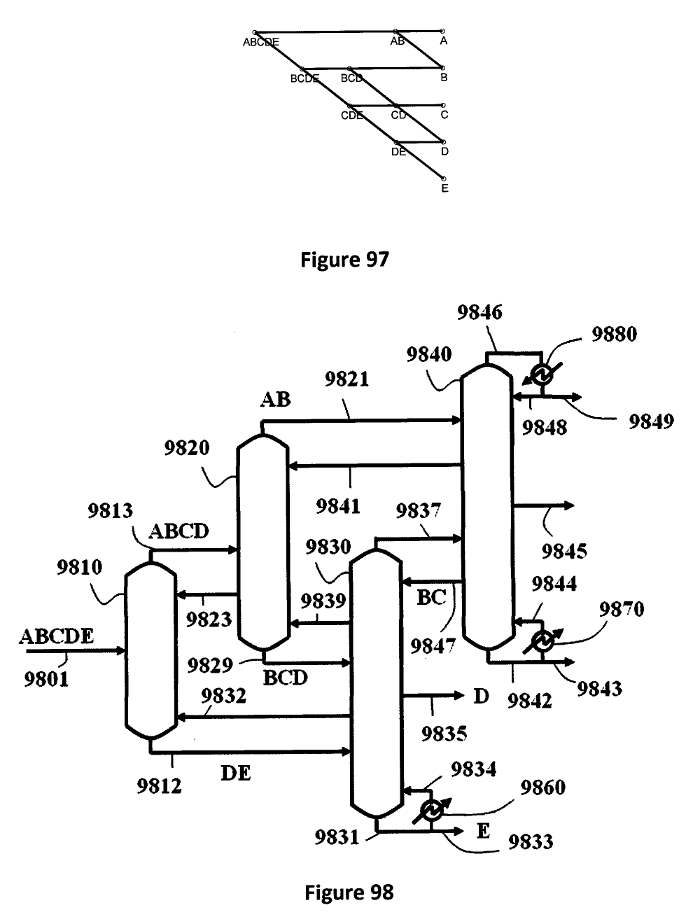

In order to simplify the description of the sixty-three distillation column configurations according to this embodiment of the present disclosure, each configuration is shown in FIGS. 35-97 in the form of a graph as further defined below. An edge of a graph represents a column section while a node represents a stream. An edge that moves horizontally to the right indicates the presence of a rectifying section in the distillation column system, and an edge that moves diagonally to the right represents the presence of a stripping section in the distillation column system. An edge always moves from left to right from a feed node (stream) to a product node (stream). One skilled in the art will understand that each graph provides a means to list the rectifying and stripping sections of the depicted distillation column system, and thus list all corresponding feeds and products. A feed stream that forms two products via a rectifying section and a stripping section is referred to as a split. Once this is done, all the rectifying and stripping sections having common products may be grouped together in the same distillation column.

For example, the graph of FIG. 47 starts with the feed stream ABCDE. ABCDE forms stream ABCD via a rectifying section (as seen by following the edge moving horizontally to the right), and stream DE via a stripping section (as seen by following the edge moving diagonally to the right). Similarly, stream ABCD forms stream AB via a rectifying section and stream BCD via a stripping section. Similarly, stream AB forms streams A and B, stream BCD forms stream BC and D, stream BC forms streams B and C, and finally stream DE forms streams D and E. Thus the list of feeds and products described by FIG. 47 is provided in Table 2 below.

TABLE 2

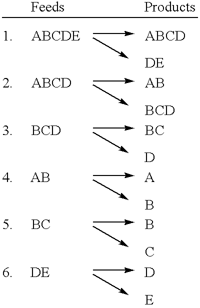

Since splits 4 and 5 described in Table 2 for the configuration of FIG. 47 make a common product B, they can be placed in the same distillation column. Similarly, splits 3 and 6 make a common product D and can also be placed into a single distillation column. Upon assigning appropriate column numbers to the splits, the distillation configuration as shown in FIG. 98 and described in Table 3 is obtained. Similarly all the configurations shown in the form of graphs in FIGS. 35-97 can be easily and uniquely converted to distillation configurations similar to that shown in FIG. 98.

TABLE 3

1. ABCDE - ABCD/DE - Distillation column 9810
2. ABCD - AB/BCD - Distillation column 9820
3. BCD - BC/D - Distillation column 9830
4. AB - A/B - Distillation column 9840
5. BC - B/C - Distillation column 9840
6. DE - D/E - Distillation column 9830

In order to further demonstrate this procedure another example using the distillation column configuration as shown in FIG. 89 may be used. The configuration of FIG. 89 starts with the feed stream ABCDE. Stream ABCDE forms stream ABCD via a rectifying section and stream BCDE via a stripping section. Similarly, stream ABCD forms stream ABC via a rectifying section and stream CD via a stripping section. Similarly, stream BCDE forms streams BC and CDE, stream ABC forms streams AB and BC, stream CDE forms stream CD and DE, stream AB forms streams A and B, stream BC forms streams B and C, stream CD forms streams C and D, and finally stream DE forms streams D and E. Thus the list of feeds and products described by FIG. 89 may be described as shown in Table 4 below.

Since splits 3 and 4 described in Table 4 for the configuration of FIG. 89 make a common product BC, they must be placed in the same distillation column. Similarly, splits 2 and 5 make a common product CD and can be placed into a single distillation column. Since splits 6 and 7 also make a common product B, they can be placed into a single column. However, since split 7 also makes a common product C with split 8, and splits 8 and 9 also make a common product D, then splits 6, 7, 8, and 9 are placed into the same distillation column. Upon assigning appropriate column numbers to the splits, the four-column distillation configuration as described in Table 5 is obtained.

TABLE 4

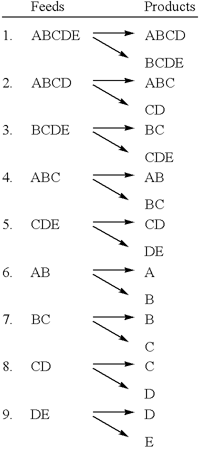

TABLE 5

1. ABCDE - ABCD/BCDE - Distillation column (1)
2. ABCD - ABC/CD - Distillation column (2)
3. BCDE - BC/CDE - Distillation column (3)
4. ABC - AB/BC - Distillation column (3)
5. BCD - BC/CD - Distillation column (2)
6. AB - A/B - Distillation column (4)
7. BC - B/C - Distillation column (4)
8. CD - C/D - Distillation column (4)
9. DE - D/E - Distillation column (4)

In the distillation configuration shown in FIG. 98, the feed mixture ABCDE (stream 9801) is fed to the first distillation column 9810. An appropriate number of separation stages are used between the feed location and the bottom of the first distillation column 9810 to reduce the concentration of components A, B and C to the desired low values. A liquid stream 9812 enriched in components D and E is withdrawn from the bottom of the first distillation column and fed to the third distillation column 9830. A vapor stream 9832 enriched in components D and E is withdrawn from the third distillation column 9830 at a location near the introduction of liquid stream 9812 and is fed near the bottom of the first distillation column 9810. Such two way liquid-vapor communication between two columns is referred to as thermal coupling between columns. Similarly an appropriate number of separation stages are used between the feed location and the top of the first distillation column 9810 to reduce the concentration of component E to the desired value in the ascending vapor stream.

From the top of distillation column 9810 a vapor stream 9813 is withdrawn and fed to the second distillation column 9820. From almost the same location as the introduction of stream 9813, a liquid stream 9823 comprising mainly of components A, B, C and D is withdrawn from the second distillation column 9820 and fed near the top of the first distillation column 9810 in a thermal coupling mode between the columns 9810 and 9820. Next, the required number of separation stages are used in the sections of the second distillation column 9820 above and below the feed to reduce the concentration of components C and D in the ascending vapor, and to reduce the concentration of component A in the descending liquid respectively, to the desired low values. Then vapor stream 9821 comprising mainly of components A and B is withdrawn from the top of the distillation column 9820 and fed to the fourth distillation column 9840. In a thermal coupling mode between columns 9820 and 9840, a liquid stream 9841 comprising of mainly components A and B is withdrawn from distillation column 9840 from nearly the same location as the introduction of vapor stream 9821, and fed near the top of distillation column 9820. Similarly liquid stream 9829 is withdrawn from the bottom of distillation column 9820 and fed to the third distillation column 9830, and a liquid stream 9839 is withdrawn from column 9830 and fed to the second distillation column 9820 in a thermal coupling mode between the columns 9820 and 9830.

Next, another appropriate number of separation stages are used between the introduction of stream 9812 and the bottom of the third distillation column 9830 to reduce the concentration of component D to the desired low value. A liquid stream 9831 enriched in component E (residue) is withdrawn from the bottom of the column 9830. A part of this stream is withdrawn as E-enriched liquid product stream 9833, while the remaining portion is vaporized in reboiler 9860 and provided as reboil stream 9834 back to column 9830. Also an appropriate number of separation stages are used above the introduction of stream 9812 to reduce the concentration of E to the desired low value in the ascending vapor stream. Here, D-enriched product stream 9835 is withdrawn as a side-draw. Similarly an appropriate number of separation stages are used between the introduction location of liquid stream 9829 and the withdrawal location of D-enriched product stream 9835 in column 9830, and also between the introduction location of liquid stream 9829 and the top of the distillation column 9830.

Vapor stream 9837 from the top of column 9830 and liquid stream 9847 from the fourth distillation column 9840 provide thermal coupling between columns 9830 and 9840. Next an appropriate number of separation stages are used in all four sections of distillation column 9840 to carry out the required separations. B-enriched product stream 9845 is withdrawn from an intermediate location of column 9840. Liquid stream 9842 is withdrawn from the bottom of column 9840 and it comprises mainly of component C. Part of this stream is withdrawn as product stream 9843, while the remainder is vaporized in reboiler 9870 to provide vapor reboil to column 9840 as stream 9844. Similarly, vapor stream 9846 is withdrawn from the top of column 9840 and it comprises mainly of component A. This stream is condensed in condenser 9880, and part of the condensed stream is withdrawn as A-enriched product stream 9849, while the remainder provides liquid reflux to column 9840 as stream 9848.

In the configuration of FIG. 98, all the transfer streams that have either the top or the bottom of a distillation column involved at one of its ends, are shown as thermally coupled. When in a distillation column system, all such existing transfer stream connections have been converted to thermally coupled transfers; the distillation column system is referred to as being completely thermally coupled. Even though the distillation column system in FIG. 98 is shown with complete thermal coupling, it could be drawn with reduced (i.e. partial) or no thermal coupling without departing from the scope of the present disclosure.

Referring now to FIG. 35, a key distinguishing feature of this process is the transfer of five submixture streams between the distillation columns. One skilled in the art will understand that the transfer of streams BCDE, BCD and CD between the columns has been missing from conventional processes as shown in FIG. 1. These submixtures are mainly composed of the components of intermediate volatility, and the lightest component A and the heaviest component E are either absent, or are present in only appreciably low quantities. All processes of the current invention may have such additional transfers.

The distillation column systems described in FIGS. 35-51 involve the transfer of one stream involving the heaviest component E., i.e., they involve the transfer of one of the streams selected from the group of BCDE, CDE, and DE. In each of the configurations described in FIGS. 35-51, stream AB is always transferred between distillation columns.

Referring now to FIGS. 35-41, distillation configurations that involve transfer of stream BCDE from the first distillation column to one of the other three distillation columns of the distillation column system are shown. In each of the seven configurations shown in FIGS. 35-41 stream BCD is transferred between distillation columns. In addition, in FIGS. 35-40, stream ABCD is transferred, and at least one of streams BC or CD is transferred between distillation columns of the distillation column system, and stream ABC may or may not be transferred between distillation columns of the distillation column system. The distillation column system configurations shown in FIGS. 35-37 do not have to transfer stream ABC, but rather transfers stream CD (FIG. 35) or stream BC (FIG. 36) or both BC and CD (FIG. 37). Similarly the configurations of FIGS. 38-40 involve the transfer of stream ABC, and then the transfer of stream CD (FIG. 38) or stream BC (FIG. 39) or both BC and CD (FIG. 40). The distillation column system configuration of FIG. 41 does not involve only the transfer of stream ABC, but also involves transfers of all three streams ABC, BC and CD.

Referring now to FIGS. 42-46, distillation configurations that involve the transfer of stream CDE from the first distillation column to one of the other three distillation columns of the distillation column system are shown. In each of these five configurations, streams ABCD and CD are transferred between distillation columns. In addition, when stream BCD is transferred, then streams ABC and BC may or may not be transferred. Thus the configurations shown in FIGS. 42-45 transfers stream BCD, and either does not transfer streams ABC and BC (FIG. 42), transfers stream BC only (FIG. 43), transfers stream ABC only (FIG. 44), or transfers both ABC and BC (FIG. 45). In FIG. 46, the distillation column configuration shown does not transfer stream BCD, but rather transfers both streams ABC and BC between distillation columns of the distillation column system.

Referring now to FIGS. 47-51, distillation configurations that involve the transfer of stream DE from the first distillation column to one of the other three distillation columns of the distillation column system are shown. In each of these five configurations streams ABCD and BC are transferred between distillation columns. However, when stream BCD is transferred, then streams ABC and CD may or may not be transferred. Thus the distillation column configurations shown in FIGS. 47-50 transfers stream BCD, and either does not transfer streams ABC and CD (FIG. 47), transfers stream CD (FIG. 48), transfers stream ABC (FIG. 49), or transfers both ABC and CD (FIG. 50). In the distillation column configuration of FIG. 51, stream BCD is not transferred, but rather streams ABC and CD are both transferred between distillation columns of the distillation column system.

Referring now to FIGS. 52-82, distillation column system configurations which involve the transfer of two streams involving the heaviest component E. In other words, these configurations involve the transfer of two of streams selected from the group of BCDE, CDE and DE. The distillation column system configurations shown in FIGS. 52-59 involve transfers of streams CDE and DE. In each of these eight configurations the transfer of stream AB between distillation columns of the distillation column system occurs. However, when stream BCD is transferred, then stream ABCD is also transferred, and at least one of the streams BC or CD is transferred. In this case, stream ABC may or may not be transferred between distillation columns. When stream BCD is not transferred, then streams ABC, BC, and CD are transferred, and stream ABCD may or may not be transferred between distillation columns of the distillation column system. Thus the configurations shown in FIGS. 52-57 involve the transfer of stream BCD and also the transfer of stream ABCD. The configurations shown in FIGS. 52-54 do not involve the transfer of stream ABC, but rather the transfer of either stream CD (FIG. 52), stream BC (FIG. 53), or both streams BC and CD (FIG. 54). Similarly, the configurations of FIGS. 55-57 involve the transfer of stream ABC and either the transfer of stream CD (FIG. 55), stream BC (FIG. 56), or both streams BC and CD (FIG. 57). The configurations shown in FIGS. 58 and 59 do not involve the transfer of stream BCD, but rather involve transfers of all of the streams ABC, BC, and CD. In addition, stream ABCD may be transferred (FIG. 58) or may not be transferred (FIG. 59).

Referring now to FIGS. 60-72, distillation configurations that involve transfer of streams BCDE and DE are shown. In these thirteen configurations, when stream AB is transferred between distillation columns, then at least one of the streams selected from ABCD and BC is transferred such that if only stream ABCD is transferred, then streams BCD and CD are also transferred and stream ABC may or may not be transferred. However, if only stream BC is transferred, then stream BCD is also transferred and at least one of streams ABC and CD is transferred. Finally, if streams ABCD and BC are both transferred, then at least one of streams selected from the group of ABC, BCD, and CD is transferred. When stream AB is not transferred between distillation columns, then all of the streams ABCD, ABC, BCD, BC, and CD are transferred between distillation columns of the distillation column system. Thus the distillation configurations shown in FIGS. 60-71 involve the transfer of stream AB and at least one of the streams ABCD or BC.

In the distillation configurations of FIGS. 60 and 61, only stream ABCD is transferred, and hence streams BCD and CD are also transferred, and stream ABC may not be transferred (FIG. 60) or may be transferred (FIG. 61). In the distillation configurations of FIGS. 62-64, only stream BC is transferred, and hence stream BCD is also transferred along with at least one of streams selected from ABC and CD. Thus these configurations result in either the transfer of stream CD (FIG. 62), the transfer of stream ABC (FIG. 63), or the transfer of both streams ABC and CD (FIG. 64). Finally, in FIGS. 65-71, streams ABCD and BC are both transferred, as well as at least one of streams selected from the group of ABC, BCD, and CD is transferred. Thus these configurations transfer stream CD (FIG. 65), transfer stream BCD (FIG. 66), transfer stream ABC (FIG. 67), transfer streams BCD and CD (FIG. 68), transfer streams ABC and CD (FIG. 69), transfer streams ABC and BCD (FIG. 70), or transfer all three streams ABC, BCD, and CD (FIG. 71). Finally, the configuration shown in FIG. 72 does not involve the transfer of stream AB between distillation columns of the distillation column system, but rather involves the transfer of all of the streams ABCD, ABC, BCD, BC, and CD between distillation columns.

Referring now to FIGS. 73-82, distillation configurations that involve transfer of streams BCDE and CDE are shown. In each of these ten configurations stream CD is transferred between distillation columns. However, when stream AB is transferred between distillation columns, then at least one of the streams ABCD or ABC is transferred between distillation columns and also at least one of the streams BCD or BC is transferred between distillation columns. If stream AB is not transferred between distillation columns, then all of the streams ABCD, ABC, BCD, and BC are transferred between distillation columns of the distillation column system. Thus the distillation column system configurations shown in FIGS. 73-81 involve the transfer of stream AB, as well as the transfer of at least one of the streams ABCD or ABC and at least one of the streams BCD or BC. Thus these configurations either transfer streams ABC and BC (FIG. 73), streams ABCD and BC (FIG. 74), streams ABCD, ABC, and BC (FIG. 75), streams ABC and BCD (FIG. 76), streams ABCD and BCD (FIG. 77), streams ABCD and ABC and BCD (FIG. 78), streams ABC, BCD, and BC (FIG. 79), streams ABCD, BCD, and BC (FIG. 80), or streams ABCD, ABC, BCD, and BC (FIG. 81). Finally, the distillation column configuration shown in FIG. 82 does not transfer stream AB, but rather each of the streams ABCD, ABC, BCD, and BC are transferred between distillation columns of the distillation column system.

Referring now to FIGS. 83-97, distillation column systems that transfer all three streams that involve the heaviest component E is shown. These configurations transfer each of the streams BCDE, CDE, and DE. In all of these fifteen configurations, if streams AB and BC are both transferred between distillation columns, then stream CD may or may not be transferred between distillation columns. When stream CD is transferred, then streams ABCD, ABC and BCD may or may not be transferred between distillation columns of the distillation column system. When stream CD is not transferred, then at least two of the streams selected from the group of ABCD, ABC, and BCD are transferred between distillation columns of the distillation column system. In all of these configurations, when stream BC is transferred between distillation columns and stream AB is not transferred between distillation columns, then stream CD is not transferred between distillation columns and all of the streams ABCD, ABC and BCD are transferred between distillation columns. However, when stream BC is not transferred between distillation columns and stream AB is transferred between distillation columns, then streams BCD and CD are also transferred between distillation columns and either streams ABCD and ABC are both transferred between distillation columns or streams ABCD and ABC are both not transferred between distillation columns of the distillation column system.

The distillation column system configurations shown in FIGS. 83-94 represent twelve configurations that involve the transfer of streams AB and BC. In the configurations of FIGS. 83-90, stream CD is transferred between distillation columns, and streams ABCD, ABC, and BCD may or may not be transferred between distillation columns. Thus these configurations either transfer none of the streams ABCD, ABC, and BCD (FIG. 83), transfer stream BCD only (FIG. 84), transfer stream ABC only (FIG. 85), transfer streams ABC and BCD (FIG. 86), transfer stream ABCD only (FIG. 87), transfer streams ABCD and BCD (FIG. 88), transfer streams ABCD and ABC (FIG. 89), or transfer each of the streams ABCD, ABC, and BCD (FIG. 90).

In the distillation column configurations shown in FIGS. 91-94, stream CD is not transferred between distillation columns, but rather at least two of the streams selected from the group of ABCD, ABC, and BCD are transferred between distillation columns. These configurations transfer streams ABC and BCD only (FIG. 91), transfers streams ABCD and BCD only (FIG. 92), transfer of streams ABCD and ABC only (FIG. 93), or transfer each of the streams ABCD, ABC, and BCD (FIG. 94). In the configuration of FIG. 95, stream BC is transferred between distillation columns and streams AB and CD are not transferred between distillation columns. In this configuration, each of the streams ABCD, ABC and BCD are transferred between distillation columns. Finally, in configurations shown in FIGS. 96 and 97, stream BC is not transferred between distillation columns and stream AB is transferred between distillation columns. In addition, streams BCD and CD are transferred between distillation columns and either streams ABCD and ABC are both transferred between distillation columns (FIG. 96) or streams ABCD and ABC are both not transferred between distillation columns of the distillation column system (FIG. 97).

Various distillation column system configurations derived from FIGS. 35-97 may include configurations that have no thermal coupling, partial thermal coupling, or complete thermal coupling. For each of these configurations, one skilled in the art will understand from the contents of the present disclosure how to identify the sections that can be rearranged and how to draw all possible sequences. The designer can then choose the configurations that are easier to operate, or the ones that meet the required constraints for the intended application. All such arrangements are anticipated by the processes and systems of the present disclosure.

The distillation column system configurations and processes of the current disclosure may be part of a larger distillation column system that produces more than five product streams. In other words, the distillation column system configurations of the present disclosure may be a component of larger system where a five-component stream is produced somewhere in the larger distillation column system with such five-component stream being separated into five product streams using one of the processes of the current disclosure.

The processes and systems of the current disclosure may also include heat integration. Heat integration means that the process or system uses the heat of a stream that is cooled to provide heat to a stream that is heated (thereby reducing the conventional heating and cooling utility requirement), provided the temperatures of the streams are appropriate for heat transfer. For example, when appropriate, a condenser and a reboiler in the distillation column system can be replaced by a single heat exchanger.

In addition, pump-around loops can be used to remove heat from intermediate locations of suitable rectifying sections in the configurations of the present disclosure. The definition and use of pump-around loops as used in conventional process, such as that shown in FIG. 1, is illustrated by Liebmann and Dhole in Comput. Chem. Eng., 1995, 19, 119-124, the contents of which are hereby incorporated by reference. Appropriate use of such pump-around loops is expected to improve the performance of the distillation column system. Also, intermediate condensers may be used to remove heat from an intermediate location of a rectifying section of a distillation column. The ratio of countercurrent molar liquid to vapor flow is generally less than one in a rectifying section, and is generally greater than one in a stripping section. Thus in FIG. 9, some of the locations where pump-around loops or intermediate condensers may be used include, but are not limited to, anywhere in the first column 900 above the feedstock ABCDE or above the feed BC in the distillation column 970. In FIG. 98, some of the locations where pump-around loops or intermediate condensers may be used include, but are not limited to, the first column 6710 above the feed ABCDE and above the feed ABCD in the second distillation column 6720.

Any reboilers present in the distillation column systems of the present disclosure may be partially or completely replaced with direct steam injection. Thus in FIG. 9, reboilers C, D, and E can be replaced by direct steam injection. Furthermore, in order to increase the thermodynamic efficiency of the process, steam may be directly injected at suitable locations in the stripping sections of distillation columns present in the distillation column system. Alternatively, intermediate reboilers may also be used. Thus steam may be directly injected in any of the sections of distillation column 950 of FIG. 9. In addition, reboilers E and C (i.e., reboilers 6760 and 6770) can be replaced by direct steam injection in the configuration shown in FIG. 98. Furthermore, to increase the thermodynamic efficiency of the process, steam may be directly injected at suitable locations of the stripping sections of distillation columns of the distillation column system. Alternatively, intermediate reboilers may also be used. Thus steam may be directly injected in the stripping section of distillation column 6710 of the configuration shown in FIG. 98.

Finally the processes of the current disclosure are applicable to varying petroleum crude mixture compositions. It is anticipated that some distillation column system configurations of the current disclosure will be more suitable than other distillation column system configurations of the current disclosure for certain petroleum crude mixture compositions. The processes of the current disclosure are expected to be beneficial for the separation of other five-component feed mixtures that are similar to the petroleum crude mixtures and like petroleum crude. Preferably, the feedstock is to be separated into five product streams.

The following specific examples are given to illustrate the invention and should not be construed to limit the scope of the invention.

### EXAMPLE 1

One aspect of this example demonstrates the advantage of the processes of the current disclosure as compared to the conventional configuration shown in FIG. 1. Separation of a five-component mixture containing 46.1% A, 19.5% B, 7.3% C, 11.4% D and 15.7% E into pure components was considered. The relative volatility of A with respect to E was taken to be 45.3, of B with respect to E was taken to be 14.4, of C with respect to E was taken to be 4.7, and of D with respect to E was taken to be 2.0. Ninety percent (90%) of the E in the feed was taken to be liquid, while the remaining 10% of the feed was taken to be vapor. Thus this feedstock is a two-phase feed. The values provided above are substantially similar to the values expected for a ‘light’ petroleum crude mixture. One skilled in the art will understand how to use Underwood's equations to calculate the minimum vapor flow of the distillation configurations to separate one mole of feed into five pure product streams. A further description is provided by A. Underwood in Chem. Eng. Prog., 1948, 44, 603-614, the entire contents of which are herein incorporated by reference.

The conventional petroleum crude distillation process shown in FIG. 1 with complete thermal coupling requires generation of 0.681 moles of total vapor flow per mole of feed flow to carry out the desired separation. This vapor flow is the summation of all individual column vapor flow requirements and provides total vapor demand. This total vapor demand is directly proportional to the total heat duty. The total vapor flow requirements for various distillation configurations of the current disclosure containing complete thermal coupling to carry out the desired separation are summarized in Table 6 below.

TABLE 6

| | Total vapor flow requirement | % Reduction in vapor flow as |
|---|---|---|
| FIG. | (moles/mol feed) | compared to FIG. 1 |
| 4 | 0.637 | 6.5 |
| 5 | 0.598 | 12.3 |
| 6 | 0.641 | 7.6 |
| 7 | 0.630 | 5.9 |
| 8 | 0.572 | 16.0 |
| 9 | 0.549 | 15.1 |
| 10 | 0.578 | 19.4 |
| 11 | 0.549 | 19.4 |

This example demonstrates that the processes of the current disclosure reduce energy consumption up to nearly 19.4% as compared to the conventional petroleum crude distillation process for separating a light petroleum crude mixture.

### EXAMPLE 2

One aspect of this example shows the advantage of the processes of the current invention as compared to the conventional configuration shown in FIG. 1. Separation of a five-component mixture containing 14.4% A, 9.3% B, 10.1% C, 3.9% D and 62.3% E into pure components was considered. The relative volatility of A with respect to E was taken to be 45.3, of B with respect to E was taken to be 14.4, of C with respect to E was taken to be 4.7, and of D with respect to E was taken to be 2.0. Ninety (90%) of the E in the feed was taken to be liquid, while the remaining 10% of the feed was taken to be vapor. Thus this feedstock is a two-phase feed. The values provided above are substantially similar to the values expected for a ‘heavy’ petroleum crude mixture. Once again, Underwood's equations as described in Example 1 were used to calculate the minimum vapor flow of the distillation configurations to separate one mole of feed into five pure product streams. The conventional petroleum crude distillation process shown in FIG. 1 with complete thermal coupling needs the generation of 0.846 moles of total vapor flow per mole of feed to carry out the desired separation. The vapor flow requirements for various distillation configurations of the current disclosure containing complete thermal coupling to carry out the desired separation are summarized in Table 7 below.

TABLE 7

| | Total vapor flow requirement | % Reduction in vapor flow as |
|---|---|---|
| FIG. | (moles/mol feed) | compared to FIG. 1 |
| 6 | 0.803 | 3.8 |
| 7 | 0.817 | 5.1 |
| 8 | 0.775 | 8.3 |
| 9 | 0.803 | 5.0 |
| 10 | 0.804 | 5.0 |
| 11 | 0.772 | 8.8 |

This example demonstrates that some of the processes of the current invention reduce energy consumption up to nearly 8.8% as compared to the conventional petroleum crude distillation process for separating a heavy petroleum crude mixture. Any processes of the current disclosure that do not perform better than the conventional process of FIG. 1 would be considered unsuitable for the considered ‘heavy’ petroleum crude mixture. Thus the eight distillation configurations to separate a multicomponent mixture into five product streams shown in FIGS. 4-11 are especially attractive for separating petroleum crude as compared to the conventional distillation configuration shown in FIG. 1. The configurations shown in FIGS. 4-11 can reduce energy consumption by significant amounts.

### EXAMPLE 3

The objective of this example is to show the effect of thermal coupling ranging from partial thermal coupling to complete thermal coupling. Again, separation of the five-component mixture from Example 1 containing 46.1% A, 19.5% B, 7.3% C, 11.4% D and 15.7% E into pure components was considered. The relative volatility of A with respect to E was taken to be 45.3, of B with respect to E was taken to be 14.4, of C with respect to E was taken to be 4.7, and of D with respect to E was taken to be 2.0. Ninety percent (90%) of the E in the feed was taken to be liquid, while the remaining 10% of the feed was taken to be vapor. Thus this feedstock is a two-phase feed. The values provided above are substantially similar to the values expected for a light petroleum crude mixture and are identical to the values used in Example 1. Again, Underwood's equations were used to calculate the minimum vapor flow per mole of feed for each of the distillation configurations to separate feed into five pure product streams.

However, in this Example one does not evaluate vapor flow in the distillation column systems of FIGS. 4-11. Rather the distillation column configuration of FIG. 12 is used because it is equivalent to the distillation column configuration of FIG. 4. The configuration in FIG. 12 has complete thermal coupling. If all the streams having thermal coupling in FIG. 12 are replaced with reboilers and condensers as appropriate, the configuration shown in FIG. 13 is obtained. Since FIG. 13 has no thermal coupling, we cannot rearrange column sections.

Four streams—ABCD, AB, BCD and BC—are candidate streams for thermal coupling. If thermal coupling is systematically introduced into these streams, a total of 2⁴-1 or 15 options exist. These options are shown in FIGS. 12-27. Since the configuration shown in FIG. 13 has no thermal coupling, it can be considered to be the base case. All of the other configurations shown in FIGS. 12-27 are derived from the configuration of FIG. 13 and have partial or complete thermal coupling. The vapor flow requirements of the distillation configurations shown in FIGS. 12-27 are summarized in Table 8. Table 8 clearly demonstrates the effect associated with introducing thermal coupling. For comparison, recall from Example 1 that the vapor flow requirement for a conventional petroleum crude distillation process with complete thermal coupling as shown in FIG. 1 is 0.681 moles per mole of feed.

TABLE 8

| | | Total vapor flow requirement |
|---|---|---|
| Streams having thermal coupling | FIG. | (moles/mol feed) |
| -none- | 13 | 0.842 |
| BC | 14 | 0.711 |
| AB | 15 | 0.743 |
| AB, BC | 16 | 0.703 |
| BCD | 17 | 0.825 |
| BCD, BC | 18 | 0.711 |
| BCD, AB | 19 | 0.724 |
| BCD, AB, BC | 20 | 0.687 |
| ABCD | 21 | 0.822 |
| ABCD, BC | 22 | 0.687 |
| ABCD, AB | 23 | 0.682 |
| ABCD, AB, BC | 24 | 0.648 |
| ABCD, BCD | 25 | 0.810 |
| ABCD, BCD, BC | 26 | 0.687 |
| ABCD, BCD, AB | 27 | 0.668 |
| ABCD, BCD, AB, BC | 12 | 0.637 |

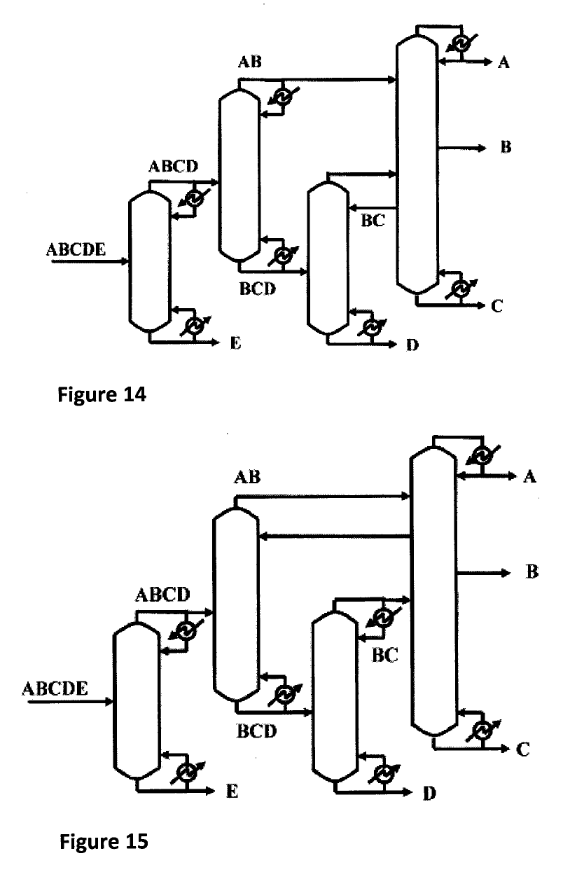

Although the distillation system configuration of FIG. 14 has just one stream having thermal coupling, it is shown to consume nearly 16% less energy than the distillation system of FIG. 13. In contrast the distillation system of FIG. 12 has all four streams with thermal coupling i.e. complete thermal coupling, and it consumes only about 24% less energy than the distillation system of FIG. 13. The distillation column system of FIG. 12 consumes the least energy among the distillation systems shown in FIGS. 12-27. Thus the added design and operating factors due to more streams having thermal coupling may not be worth the additional gain obtained in reduced energy consumption as illustrated by the comparison between FIG. 14 and FIG. 12. This trade-off is handled by the designer, engineer, and operator depending upon the particular application at hand.

The processes shown in FIGS. 24, 27, and 12 consume less energy than the conventional petroleum crude distillation process with complete thermal coupling shown in FIG. 1. Generally, as degree of thermal coupling is increased within a distillation configuration, its heat duty requirement decreases. The equivalent structure of the conventional process in FIG. 1 with no thermal coupling demands higher heat duty than the configuration with no thermal coupling shown in FIG. 13. The choice of the degree of thermal coupling used will depend on various factors including, but not limited to, the desired heat savings and operability.

### EXAMPLE 4

The objective of this example is to further demonstrate the advantage of the processes of the current disclosure as compared to the conventional configuration shown in FIG. 1. Separation of a five-component mixture containing 46.1% A, 19.5% B, 7.3% C, 11.4% D and 15.7% E into pure components is considered. The relative volatility of A with respect to E was taken to be 45.3, of B with respect to E was taken to be 14.4, of C with respect to E was taken to be 4.7, and of D with respect to E was taken to be 2.0. Ninety percent (90%) of the E in the feed was taken to be liquid, while the remaining 10% of the feed was taken to be vapor. Thus this feedstock is a two-phase feed. The values provided above are substantially similar to the values described in Example 1 with respect to a ‘light’ petroleum crude mixture. Once again, Underwood's equations were used to calculate the minimum vapor flow of the distillation configurations to separate one mole of feed into five pure product streams.

The conventional petroleum crude distillation process shown in FIG. 1 (with complete thermal coupling) requires the generation of 0.681 moles of total vapor flow per mole of feed flow to carry out the desired separation. This vapor flow is the summation of all individual column vapor flow requirements and provides total vapor demand. This total vapor demand is directly proportional to the total heat duty. The following Table 9 summarizes the total vapor flow requirements for various distillation configurations of the present disclosure containing no thermal coupling and complete thermal coupling to carry out the desired separation.

TABLE 9

| | Total vapor flow | | Total vapor flow | |
|---|---|---|---|---|
| | requirement without | % Reduction in | requirement with | % Reduction in |
| | thermal coupling | vapor flow as | complete thermal | vapor flow as |
| FIG. | (moles/mol feed) | compared to FIG. 1 | coupling (moles/mol feed) | compared to FIG. 1 |
| 35 | 0.644 | 5.4 | 0.6 | 11.9 |
| 36 | 0.631 | 7.3 | 0.531 | 22 |
| 37 | 0.558 | 18.1 | 0.5 | 26.6 |
| 38 | 0.56 | 17.8 | 0.455 | 33.2 |
| 39 | 0.654 | 3.9 | 0.538 | 21 |
| 40 | 0.517 | 24.1 | 0.446 | 34.5 |
| 41 | 0.676 | 0.7 | 0.612 | 10.1 |
| 42 | 0.651 | 4.4 | 0.545 | 20 |
| 43 | 0.554 | 18.6 | 0.466 | 31.6 |
| 44 | 0.571 | 16.2 | 0.446 | 34.5 |
| 45 | 0.605 | 11.2 | 0.453 | 33.5 |
| 46 | 0.601 | 11.7 | 0.484 | 28.9 |
| 47 | 0.652 | 4.3 | 0.41 | 39.8 |
| 48 | 0.572 | 16 | 0.359 | 47.3 |
| 49 | 0.607 | 10.9 | 0.413 | 39.4 |
| 50 | 0.621 | 8.8 | 0.359 | 47.3 |
| 51 | 0.57 | 16.3 | 0.382 | 43.9 |
| 52 | 0.627 | 7.9 | 0.492 | 27.8 |
| 53 | 0.629 | 7.6 | 0.373 | 45.2 |
| 54 | 0.512 | 24.8 | 0.353 | 48.2 |
| 55 | 0.591 | 13.2 | 0.471 | 30.8 |
| 56 | 0.671 | 1.5 | 0.383 | 43.8 |
| 57 | 0.506 | 25.7 | 0.358 | 47.4 |
| 58 | 0.639 | 6.2 | 0.474 | 30.4 |
| 59 | 0.534 | 21.6 | 0.353 | 48.2 |
| 60 | 0.584 | 14.2 | 0.41 | 39.8 |
| 61 | 0.569 | 16.4 | 0.353 | 48.2 |
| 62 | 0.649 | 4.7 | 0.546 | 19.8 |
| 63 | 0.642 | 5.7 | 0.521 | 23.5 |
| 64 | 0.613 | 10 | 0.526 | 22.8 |
| 65 | 0.597 | 12.3 | 0.375 | 44.9 |
| 66 | 0.524 | 23.1 | 0.401 | 41.1 |
| 67 | 0.667 | 2.1 | 0.46 | 32.5 |
| 68 | 0.494 | 27.5 | 0.353 | 48.2 |
| 69 | 0.559 | 17.9 | 0.397 | 41.7 |
| 70 | 0.532 | 21.9 | 0.421 | 38.2 |
| 71 | 0.465 | 31.7 | 0.353 | 48.2 |
| 72 | 0.656 | 3.7 | 0.549 | 19.4 |
| 73 | 0.678 | 0.4 | 0.591 | 13.2 |
| 74 | 0.548 | 19.5 | 0.494 | 27.5 |
| 75 | 0.554 | 18.6 | 0.467 | 31.4 |
| 76 | 0.625 | 8.2 | 0.584 | 14.2 |
| 77 | 0.604 | 11.3 | 0.521 | 23.5 |
| 78 | 0.551 | 19.1 | 0.457 | 32.9 |
| 79 | 0.661 | 2.9 | 0.548 | 19.5 |
| 80 | 0.556 | 18.4 | 0.466 | 31.6 |
| 81 | 0.545 | 20 | 0.452 | 33.6 |
| 82 | 0.664 | 2.5 | 0.556 | 18.4 |
| 83 | 0.671 | 1.5 | 0.552 | 18.9 |
| 84 | 0.681 | 0 | 0.536 | 21.3 |
| 85 | 0.647 | 5 | 0.529 | 22.3 |
| 86 | 0.645 | 5.3 | 0.464 | 31.9 |
| 87 | 0.494 | 27.5 | 0.355 | 47.9 |
| 88 | 0.576 | 15.4 | 0.353 | 48.2 |
| 89 | 0.528 | 22.5 | 0.363 | 46.7 |
| 90 | 0.519 | 23.8 | 0.353 | 48.2 |
| 91 | 0.656 | 3.7 | 0.494 | 27.5 |
| 92 | 0.521 | 23.5 | 0.375 | 44.9 |
| 93 | 0.667 | 2.1 | 0.422 | 38 |
| 94 | 0.581 | 14.7 | 0.369 | 45.8 |
| 95 | 0.677 | 0.6 | 0.603 | 11.5 |
| 96 | 0.629 | 7.6 | 0.372 | 45.4 |
| 97 | 0.675 | 0.9 | 0.55 | 19.2 |

This example demonstrates that the processes of the present disclosure can reduce energy consumption up to nearly 48.2% as compared to the conventional petroleum crude distillation process for separating a light petroleum crude mixture. Thus FIGS. 35-97 describe sixty-three distillation configurations to separate a multi-component mixture into five product streams, such as petroleum crude, that are highly attractive when compared to the conventional distillation configuration shown in FIG. 1. These configurations of the present disclosure can reduce energy consumption by significant amounts.

### EXAMPLE 5

The objective of this example is to further demonstrate the advantage of the processes of the present disclosure as compared to the conventional configuration shown in FIG. 1. Separation of a five-component mixture containing 14.4% A, 9.3% B, 10.1% C, 3.9% D and 62.3% E into pure components is considered. The relative volatility of A with respect to E was taken to be 45.3, of B with respect to E was taken to be 14.4, of C with respect to E was taken to be 4.7, and of D with respect to E was taken to be 2.0. Ninety percent (90%) of the E in the feed was taken to be liquid, while the remaining 10% of the feed was taken to be vapor. Thus this feedstock is a two-phase feed. The values provided above are substantially similar to the values described in Example 2 with respect to a ‘heavy’ petroleum crude mixture. Once again, Underwood's equations were used to calculate the minimum vapor flow of the distillation configurations to separate one mole of feed into five pure product streams. The conventional petroleum crude distillation process shown in FIG. 1 (with complete thermal coupling) needs generation of 0.846 moles of total vapor flow per mole of feed to carry out the desired separation. The following Table 10 summarizes the vapor flow requirements of one of the distillation configurations of the present disclosure containing no thermal coupling and complete thermal coupling to carry out the desired separation.

TABLE 10

| | Total vapor | | | |
|---|---|---|---|---|
| | flow | | | |
| | requirement | % | | |
| | without | Reduction | Total vapor flow | |
| | thermal | in vapor | requirement with | % Reduction |
| | coupling | flow as | complete thermal | in vapor flow |
| | (moles/mol | compared | coupling (moles/mol | as compared to |
| FIG. | feed) | to FIG. 1 | feed) | FIG. 1 |
| 40 | 0.825 | 2.5 | 0.765 | 9.6 |

This example demonstrates that one of the processes of the present disclosure (FIG. 40) without thermal coupling consumes lower energy than the conventional petroleum crude distillation process with complete thermal coupling (FIG. 1) for separating a heavy petroleum crude mixture. Introducing thermal coupling in this process of the current invention further reduces the energy consumption. Similarly, some of the other processes of the current invention with partial or complete thermal coupling will also consume lower energy than the conventional petroleum crude distillation process and as such, they will be attractive for use in a ‘heavy’ crude application.

A person skilled in the art will recognize that the measurements described are standard measurements that can be obtained by a variety of different test methods. The test methods described in the examples represents only one available method to obtain each of the required measurements.

It is clear from the present disclosure and the examples used to demonstrate the principles of the present disclosure that the processes and distillation column system configurations provided herein are very attractive for crude distillation and provide configurations that match crude compositions and optimize savings in the heat duty of the system. The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A process for the separation of a multi-component feed stream containing at least five components into five product streams that are enriched in one of the components by distillation in a distillation column system containing at least four distillation columns, said process comprising:
feeding the feed stream containing at least five components A, B, C, D, and E with A being the most volatile and volatility decreasing in successive order with E being the least volatile, to the first distillation column of the distillation column system;
recovering the heaviest component E from the bottom of the first column;
transferring a four-component stream ABCD that is lean in the heaviest component E from the first distillation column to one of the other three distillation columns of the distillation column system;
transferring binary stream AB between two distillation columns of the distillation column system;
transferring at least one of the three-component streams selected from the group of ABC and BCD between two distillation columns of the distillation column system;
recovering D from the bottom of one of the other three distillation columns of the distillation column system;
recovering A from the top of one of the distillation columns of the distillation column system; and
recovering B and C from suitable locations of the same or different distillation columns from among the other three distillation columns of the distillation column system;
wherein the streams available for transfer between distillation columns include one or more of ABCD, ABC, BCD, AB, BC, and CD.

2. The process of claim 1, wherein during the step of transferring at least one of the three-component streams, when only stream ABC is transferred between two distillation columns of the distillation column system, then at least one of the binary streams selected from the group of BC and CD is also transferred between two distillation columns of the other three distillation columns of the distillation column system.

3. The process of claim 1, wherein during the step of transferring at least one of the three-component streams, when only stream BCD is transferred between two distillation columns of the distillation column system, then binary stream BC is also transferred between two distillation columns of the other three distillation columns of the distillation column system and binary stream CD may or may not be transferred between two distillation columns of the other three distillation columns of the distillation column system.

4. The process of claim 1, wherein in the step of transferring at least one of the three-component streams, when both streams ABC and BCD are transferred between two distillation columns of the distillation column system, then at least one of the binary streams selected from the group of BC and CD is also transferred between two distillation columns of the other three distillation columns of the distillation column system.

5. The process of claim 1, wherein the multi-component feed stream is a petroleum crude mixture.

6. The process of claim 4, wherein one or more of the streams being transferred are thermally coupled.

7. The process of claim 6, wherein the transfer of stream BC is not thermally coupled.

8. The process of claim 1, wherein the distillation column system used for the distillation of the multi-component feed stream includes one selected from the group of reboilers, the direct injection of steam, or a mixture thereof.

9. The process of claim 1, wherein the distillation column system used for the distillation of the multi-component feed stream includes one selected from the group of condensers, liquid pump-around loops, or a mixture thereof.

10. The process of claim 1, wherein the distillation column system used for the distillation of the multi-component feed stream includes one or more divided wall columns.

11. A process for the separation of a multi-component feed stream containing at least five components into five product streams that are enriched in one of the components by distillation in a distillation column system containing at least four distillation columns, said process comprising:
feeding the feed stream containing at least five components A, B, C, D, and E with A being the most volatile and volatility decreasing in successive order with E being the least volatile, to the first distillation column of the distillation column system;
recovering the heaviest component E from the bottom of one of the distillation columns of the distillation column system,
transferring at least one of the streams selected from the group of BCDE, CDE, and DE between two distillation columns of the distillation column system
transferring stream AB between two distillation columns of the distillation column system;
recovering component D from the bottom of one of the other three distillation columns of the distillation column system, that does not include the first distillation column to which the feed is fed;
recovering component A from the top of one of the distillation columns of the distillation column system; and
recovering components B and C from suitable locations of the same or different distillation columns from among the other three distillation columns of the distillation column system;
wherein the streams available for transfer between distillation columns include one or more of ABCD, BCDE, ABC, BCD, CDE, AB, BC, DE, and CD.

12. The process of claim 11, wherein during the step of transferring at least one of the streams selected from the group of BCDE, CDE, and DE between two distillation columns of the distillation column system, when only stream BCDE is transferred between two distillation columns of the distillation column system, then stream BCD is also transferred between two distillation columns of the distillation column system and stream ABCD may or may not be transferred from the first distillation column to one of the other three distillation columns of the distillation column system.

13. The process of claim 12, wherein stream ABCD is transferred from the first distillation column to one of the other three columns of the distillation column system and at least one stream selected from the group of BC and CD is transferred between two distillation columns of the distillation column system and stream ABC may or may not be transferred between two distillation columns of the distillation column system.

14. The process of claim 12, wherein stream ABCD is not transferred from the first distillation column to one of the other three columns of the distillation column system and streams ABC, BC, and CD are transferred between two distillation columns of the distillation column system.

15. The process of claim 11, wherein during the step of transferring at least one of the streams selected from the group of BCDE, CDE, and DE is transferred between two distillation columns of the distillation column system, when only stream CDE is transferred between two distillation columns of the distillation column system, then stream ABCD is also transferred from the first distillation column to one of the other three distillation columns of the distillation column system, stream CD is also transferred between two distillation columns of the distillation column system, and stream BCD may or may not be transferred between two distillation columns of the distillation column system.

16. The process of claim 15, wherein stream BCD is transferred between two distillation columns of the distillation column system, then streams ABCD and BC also may or may not be transferred between two distillation columns of the distillation column system.

17. The process of claim 15, wherein stream BCD is not transferred between two distillation columns of the distillation column system, then both streams ABC and BC are transferred between two distillation columns of the distillation column system.

18. The process of claim 11, wherein during the step of transferring at least one of the streams selected from the group of BCDE, CDE, and DE between two distillation columns of the distillation column system, when only stream DE is transferred between two distillation columns of the distillation column system, then stream ABCD is also transferred from the first distillation column to one of the other three distillation columns of the distillation column system, stream BC is also transferred between two distillation columns of the distillation column system, and stream BCD may or may not be transferred between two distillation columns of the distillation column system.

19. The process of claim 18, wherein stream BCD is transferred between two distillation columns of the distillation column system, then streams ABC and CD also may or may not be transferred between two distillation columns of the distillation column system.

20. The process of claim 18, wherein stream BCD is not transferred between two distillation columns of the distillation column system, then both streams ABC and CD are transferred between two distillation columns of the distillation column system.

21. The process of claim 11, wherein during the step of transferring at least one of the streams selected from the group of BCDE, CDE, and DE between two distillation columns of the distillation column system, when streams CDE and DE are transferred, then stream AB is also transferred between two distillation columns of the distillation column system and stream BCD may or may not be transferred between two distillation columns of the distillation column system.

22. The process of claim 18, wherein stream BCD is transferred between two distillation columns of the distillation column system, then stream ABCD is transferred from the first distillation column system, at least one of streams BC and CD is transferred between two distillation columns of the distillation column system, and stream ABC may or may not be transferred between two distillation columns of the distillation column system.

23. The process of claim 18, wherein stream BCD is not transferred between two distillation columns of the distillation column system, then streams ABC, BC, and CD are transferred between two distillation columns of the distillation column system, and stream ABCD may or may not be transferred from the first distillation column to one of the other three distillation columns of the distillation column system.

24. The process of claim 11, wherein during the step of transferring at least one of the streams selected from the group of BCDE, CDE, and DE between two distillation columns of the distillation column system, when streams BCDE and DE are transferred, then stream AB may or may not be transferred between two distillation columns of the distillation column system.

25. The process of claim 24, wherein stream AB is transferred between two distillation columns of the distillation column system, then at least one stream selected from the group of ABCD and BC are transferred between two distillation columns of the distillation column system.

26. The process of claim 25, wherein stream ABCD is transferred from the first distillation column to one of the other three distillation columns of the distillation column system, and streams BCD and CD are transferred between two distillation columns of the distillation column system, and stream ABC may or may not be transferred between two distillation columns of the distillation column system.

27. The process of claim 25, wherein stream BC is transferred between two distillation columns of the distillation column system, and stream BCD is also be transferred between two distillation columns of the distillation column system, and at least one of streams selected from the group of ABC and CD are transferred between two distillation columns of the distillation column system.

28. The process of claim 25, wherein both streams ABCD and BC are transferred between two distillation columns of the distillation column system, and at least one of streams selected from the group of ABC, BCD, and CD are transferred between two distillation columns of the distillation column system.

29. The process of claim 24, wherein stream AB is not transferred between two distillation columns of the distillation column system, then streams ABCD, ABC, BCD, BC, and CD are transferred between two distillation columns of the distillation column system.

30. The process of claim 11, wherein during the step of transferring at least one of the streams selected from the group of BCDE, CDE, and DE between two distillation columns of the distillation column system, when streams BCDE and CDE are transferred, then stream CD is also transferred between two distillation columns of the distillation column system and stream AB may or may not be transferred between two distillation columns of the distillation column system.

31. The process of claim 30, wherein stream AB is transferred between two distillation columns of the distillation column system, then at least one of streams selected from the group of ABCD and ABC is transferred between two distillation columns of the distillation column system, and at least one of streams selected from the group of BCD and BC is also transferred between two distillation columns of the distillation column system.

32. The process of claim 30, wherein stream AB is not transferred between two distillation columns of the distillation column system, then streams ABCD, ABC, BCD, and BC are transferred between two distillation columns of the distillation column system.

33. The process of claim 11, wherein during the step of transferring at least one of the streams selected from the group of BCDE, CDE, and DE between two distillation columns of the distillation column system, when streams BCDE, CDE, and DE are transferred, then stream BC may or may not be transferred between two distillation columns of the distillation column system.

34. The process of claim 33, wherein stream BC is transferred between two distillation columns of the distillation column system and stream AB may or may not be transferred between two distillation columns of the distillation column system.

35. The process of claim 34, wherein stream AB is transferred between two distillation columns of the distillation column system, then stream CD may or may not be transferred between two distillation columns of the distillation column system.

36. The process of claim 35, wherein stream CD is transferred, then streams ABCD, ABC, and BCD may or may not be transferred between two distillation columns of the distillation column system.

37. The process of claim 35, wherein stream CD is not transferred, then at least two of streams selected from the group of ABCD, ABC, and BCD are transferred between two distillation columns of the distillation column system.

38. The process of claim 34, wherein stream AB is not transferred between two distillation columns of the distillation column system, then stream CD is also not transferred between two distillation columns of the distillation column system, and streams ABCD, ABC, and BCD are transferred between two distillation columns of the distillation column system.

39. The process of claim 33, wherein stream BC is not transferred between two distillation columns of the distillation column system, then streams BCD, AB, and CD are transferred between two distillation columns of the distillation column system, and either streams ABCD and ABC are both transferred or are both not transferred between two distillation columns of the distillation column system.

40. The process of claim 11, wherein the multi-component feed stream is a petroleum crude mixture.

41. The process of claim 11, wherein one or more of the transfer streams are thermally coupled.

42. The process of claim 11, wherein the distillation column system used for the distillation of the multi-component feed stream includes one selected from the group of reboilers, direct injection of steam, or a mixture thereof.

43. The process of claim 11, wherein the distillation column system used for the distillation of the multi-component feed stream includes one selected from the group of condensers, liquid pump-around loops, or a mixture thereof.

44. The process of claim 11, wherein the distillation column system used for the distillation of the multi-component feed stream includes one or more divided wall columns.
